(19) United States
(12) Patent Application Publication
(10) Pub. No.: US 2012/0296689 A1
(43) Pub. Date: Nov. 22, 2012

(54) Computer Implemented Method and System for Analyzing Business Processes

(76) Inventors: Bandu Wewalaarachchi, Singapore (SG); Haritharan Gunasingham, Singapore (SG); Haran Shivanan, Colombo (LK)

(21) Appl. No.: 13/463,248

(22) Filed: May 3, 2012

(30) Foreign Application Priority Data
May 3, 2011 (SG) SG201103180-4

(51) Int. Cl. G06Q 10/06

(52) U.S. Cl. 705/7.26; 705/7.12

(57) ABSTRACT

A system and method for monitoring and managing multiple building systems with a single interface as well as customize and revise settings and automated responses for multiple building systems using input and transactions from different building systems and enterprise applications. A drop-in command and interface software module allows a user to integrate control, command and response functions between previously installed and un-integrated building systems and to configure the activation or deactivation of one system function based on the data, alarm, event, or transaction from one or more other systems. The invention takes the data and control functions from any and every control system and allows a user to build his own intelligent building, and to edit the control processes on their own at any time. Responses of building systems are process driven, rather than rules based, and the response process is fully editable by the end user.

### BACKGROUND OF THE INVENTION

This invention relates to methods and systems for monitoring and analyzing business processes. More particularly, this invention relates to software and methods for allowing a user to build, customize, and revise business process definitions, or “templates,” define process counters, timers, checkpoints, exceptions, and other process monitoring and measurement parameters, to monitor and/or analyze actual instances of the business process using the defined parameters and data collected from a SCADA system and enterprise applications, and to revise and customize the process measurement parameters thus improving the analysis, all in order to understand and improve the business process.

### BRIEF SUMMARY OF THE INVENTION

As used herein, the term business process is used to refer to any business process or activity of a business that is reasonably susceptible to standardization and for which there is a need or desire to monitor, measure and/or analyze some aspect or another. For example, a manufacturing process is a business process. As another example, the service or repair of a piece of equipment is a business process. Examples of equipment in this context may be manufacturing equipment, transportation equipment (trucks, forklifts, etc) or facility infrastructure equipment (computers, HVAC equipment, elevators, escalators, etc.). Other examples of business processes include employee hiring processes, employee training processes, employee review processes, employee grievance processes, various manufacturing process, billing and accounting processes, and complaint management/processing. As a company grows, management becomes more and more concerned with the efficiencies and inefficiencies in these various processes and looks for ways to monitor, analyze and improve the efficiencies of these process in order to improve the overall efficiency and performance of the company. Companies have therefore collected and analyzed information concerning these processes, but it is a cumbersome undertaking. This process analysis has made use of data collected by systems and software that are used or are impacted as the process instance is carried out, but most business processes require the use of or interaction with multiple enterprise applications and equipment or building systems. Accordingly, data concerning instances of a business process is captured by various different applications in multiple locations and must then be exported, consolidated offline, and formatted/normalized before it can be processed using standard analytical tools. The only exception to this paradigm is custom-built and installed manufacturing systems in which the process analysis tools are built into the process automation. In these cases, modifications of the prior art process analysis tools requires re-writing of the system software, which is time-consuming and difficult to accommodate and implement.

Due to these limitations, many opportunities are missed to change and/or improve the analysis parameters to better analyze the process under consideration and hence to identify and correct mistakes or inefficiencies in the process in a timely manner. More importantly, it is very hard using prior art process analysis methods to receive a feedback for a process modification (a change in the actual practice in doing something) because prior art systems do not allow for changes in business process, process definitions, process measurements after initial setup.

The present invention provides a computer-implemented system and method by which an end user can easily monitor and manage multiple business processes with a single interface using data collected and stored in SCADA (supervisory control and data acquisition) systems and enterprise applications, and in which the user can easily customize and revise the process definitions/templates, the process measurements, and the analysis parameters for multiple business processes, and review analyses of data collected automatically from various related and unrelated systems and enterprises.

This invention is complementary to, and may be configured to work in conjunction with or as part of, the system and application integrating command and interface software module described in U.S. application Ser. No. 12/952,675, filed Dec. 23, 2010, the entirety of which is incorporated herein by reference.

Accordingly, the present invention provides a drop-in process management layer, in the form of a software module, which, from a software architecture perspective, sits on top of the metadata layer where data and information from various systems, devices and control applications are represented and stored according to prior art supervisory and control and data acquisition systems. The present invention allows the user to access a business process definition, set measurement parameters, and collectively analyze multiple actual instances of the business process using data collected from diverse systems as the actual business process instances are carried out. Moreover, as business processes are revised, as new business processes are devised, and as new systems and applications are installed, the present invention can easily accommodate the changes without reconfiguring the entire control system. In short, the present invention, in conjunction with the invention described in U.S. application Ser. No. 12/952,675, allows a user to define measurement parameters for various business processes, and to view various analyses of the accumulated instances of the process over time using the defined measurement parameters and data collected from various systems and applications. The systems and enterprise applications that can be used to collect and present data for analysis by the invention include, but are not limited to, HVAC, fire control, access control, video monitoring, public address, exterior lighting and signage, interior public and private space lighting, escalator and elevator systems, telephone systems, room scheduling/reservation systems, resource management systems, data and information technology systems, document management systems, e-mail servers, fax servers, SMS servers, building tenant/visitor database systems, and customer relationship/management systems. Accordingly, business processes that interact with any or all of these systems, and others, can be analyzed according to the invention.

While the system of the invention may be used with the business process definitions that are established according to the process automation described in U.S. application Ser. No. 12/952,675, the process monitoring and analysis aspect of the invention may also be used to monitor and analyze business process that are automated using other systems, or business process that are partially automated, or business process that are not automated at all. According to this embodiment, the meta data later of the invention is configured to gather information that reflects the progress of the process by interfacing with the system that automates the process or, in the case of processes that are not automated, by interfacing directly with systems (such as reservation applications, customer complaint applications, and scheduling or calendar applications) that reflect the progress of the process. Once the meta data layer is populated with representations of the devices and data that reflect the aspects of the process, a business process definition can be established as described in U.S. application Ser. No. 12/952,675. In this case, however, the business process definition will not initiate the actual instances of the business process, but instead will be used to monitor and analyze accumulated instances of the actual process.

According to another aspect of the invention, the process definitions, and the number, location and character of process measurements are fully editable by the end user. For example, according to the invention, a user may have designed a smoke detection response process according to invention described in U.S. application Ser. No. 12/952,675 in which the system queries various systems to collect information and then command various systems based on the information collected. The system can be programmed to wait for end user intervention before an alarm is sounded, for example, if based on the queries, the threat level fails to meet a particular threshold. According to the present invention, the user can set various measurements for any one or all of the steps in the process definition and analyze accumulated instances of the process based on data collected in the SCADA system over time. In addition, the user can revise the measurement parameters, measurement locations, process locations and other measurement and process parameters at any time and re-run the analysis to see how changes in various variables affect the efficiencies of the business process. Significantly, process measurements can be defined for a process that is already running. Additionally, new process measurements can be applied to all process instances in the past and future. Therefore, the present invention alleviates the need for a user to anticipate all iterations and measurement variations and possibilities when the operational and analytical software is first written/implemented.

A more detailed description of features of the invention is set forth below in the detailed description of the invention, with reference to the figures. While this invention is described with respect to a work order as an exemplary business process, this invention can be used for any business process, including, but not limited to, manufacturing processes, service processes, repair processes, hiring processes, training processes, employee review processes, grievance processes, sales processes, billing processes, accounting processes, collection processes, and complaint management/processing. The following detailed description of the invention is not intended to limit or exclude these embodiments from the invention.

### BRIEF DESCRIPTION OF THE DRAWINGS

FIG. 1 is a representation of prior art SCADA systems, having a portal layer, a data layer and a device and application layer.

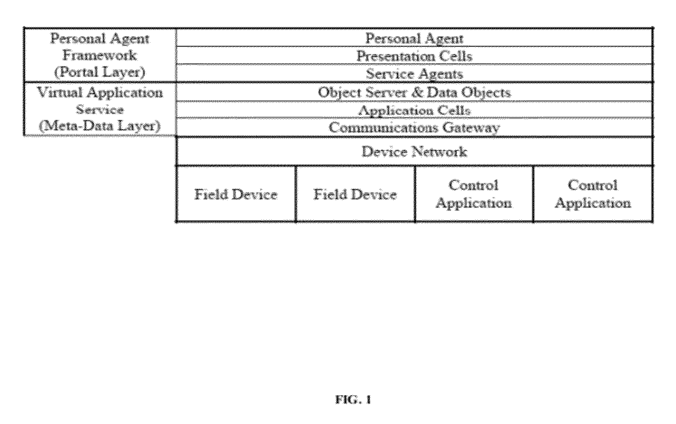

FIG. 2 is a representation of a SCADA system according to the invention, in which a process management layer resides between the portal layer and the data layer.

FIG. 3 is a representation of a computer screen that might be presented to a user by a process analyzer system according to the invention.

FIG. 4 is a representation of a computer screen that might be presented to a user by a process analyzer system according to the invention.

FIG. 5 is a representation of a computer screen that might be presented to a user by a process analyzer system according to the invention.

FIG. 6 is a representation of a computer screen that might be presented to a user by a process analyzer system according to the invention.

FIG. 7 is a representation of a computer screen that might be presented to a user by a process analyzer system according to the invention.

FIG. 8 is a representation of a computer screen that might be presented to a user by a process analyzer system according to the invention.

FIG. 9 is a representation of a computer screen that might be presented to a user by a process analyzer system according to the invention.

FIG. 10 is a representation of a computer screen that might be presented to a user by a process analyzer system according to the invention.

FIG. 11 is a representation of a computer screen that might be presented to a user by a process analyzer system according to the invention.

FIG. 12 is a representation of a computer screen that might be presented to a user by a process analyzer system according to the invention.

FIG. 13 is a representation of a computer screen that might be presented to a user by a process analyzer system according to the invention.

FIG. 14 is a representation of a computer screen that might be presented to a user by a process analyzer system according to the invention.

FIG. 15 is a representation of a computer screen that might be presented to a user by a process analyzer system according to the invention.

FIG. 16 is a representation of a computer screen that might be presented to a user by a process analyzer system according to the invention.

FIG. 17 is a representation of a computer screen that might be presented to a user by a process analyzer system according to the invention.

FIG. 18 is a representation of a computer screen that might be presented to a user by a process analyzer system according to the invention.

FIG. 19 is a representation of a computer screen that might be presented to a user by a process analyzer system according to the invention.

FIG. 20 is a representation of a computer screen that might be presented to a user by a process analyzer system according to the invention.

FIG. 21 is a representation of a computer screen that might be presented to a user by a process analyzer system according to the invention.

FIG. 22 is a representation of a computer screen that might be presented to a user by a process analyzer system according to the invention.

FIG. 23 is a representation of a computer screen that might be presented to a user by a process analyzer system according to the invention.

FIG. 24 is a representation of a computer screen that might be presented to a user by a process analyzer system according to the invention.

FIG. 25 is a representation of a computer screen that might be presented to a user by a process analyzer system according to the invention.

FIG. 26 is a representation of a computer screen that might be presented to a user by a process analyzer system according to the invention.

FIG. 27 is a representation of a computer screen that might be presented to a user by a process analyzer system according to the invention.

FIG. 28 is a representation of a computer screen that might be presented to a user by a process analyzer system according to the invention.

FIG. 29 is a representation of a computer screen that might be presented to a user by a process analyzer system according to the invention.

FIG. 30 is a representation of a computer screen that might be presented to a user by a process analyzer system according to the invention.

FIG. 31 is a representation of a computer screen that might be presented to a user by a process analyzer system according to the invention.

FIG. 32 is a representation of a computer screen that might be presented to a user by a process analyzer system according to the invention.

FIG. 33 is a representation of a computer screen that might be presented to a user by a process analyzer system according to the invention.

FIG. 34 is a representation of a computer screen that might be presented to a user by a process analyzer system according to the invention.

FIG. 35 is a representation of a computer screen that might be presented to a user by a process analyzer system according to the invention.

FIG. 36 is a representation of a computer screen that might be presented to a user by a process analyzer system according to the invention.

FIG. 37 is a representation of a computer screen that might be presented to a user by a process analyzer system according to the invention.

FIG. 38 is a representation of a computer screen that might be presented to a user by a process analyzer system according to the invention.

FIG. 39 is a representation of a computer screen that might be presented to a user by a process analyzer system according to the invention.

FIG. 40 is a representation of a computer screen that might be presented to a user by a process analyzer system according to the invention.

FIG. 41 is a representation of a computer screen that might be presented to a user by a process analyzer system according to the invention.

FIG. 42 is a representation of a computer screen that might be presented to a user by a process analyzer system according to the invention.

FIG. 43 is a representation of a computer screen that might be presented to a user by a process analyzer system according to the invention.

FIG. 44 is a representation of a computer screen that might be presented to a user by a process analyzer system according to the invention.

FIG. 45 is a representation of a computer screen that might be presented to a user by a process analyzer system according to the invention.

FIG. 46 is a representation of a computer screen that might be presented to a user by a process analyzer system according to the invention.

FIG. 47 is a representation of a computer screen that might be presented to a user by a process analyzer system according to the invention.

FIG. 48 is a representation of a computer screen that might be presented to a user by a process analyzer system according to the invention.

FIG. 49 is a representation of a computer screen that might be presented to a user by a process analyzer system according to the invention.

FIG. 50 is a representation of a computer screen that might be presented to a user by a process analyzer system according to the invention.

FIG. 51 is a representation of a computer screen that might be presented to a user by a process analyzer system according to the invention.

FIG. 52 is a representation of a computer screen that might be presented to a user by a process analyzer system according to the invention.

FIG. 53 is a representation of a computer screen that might be presented to a user by a process analyzer system according to the invention.

FIG. 54 is a representation of a computer screen that might be presented to a user by a process analyzer system according to the invention.

FIG. 55 is a representation of a computer screen that might be presented to a user by a process analyzer system according to the invention.

FIG. 56 is a representation of a computer screen that might be presented to a user by a process analyzer system according to the invention.

FIG. 57 is a representation of a computer screen that might be presented to a user by a process analyzer system according to the invention.

FIG. 58 is a representation of a computer screen that might be presented to a user by a process analyzer system according to the invention.

FIG. 59 is a representation of a computer screen that might be presented to a user by a process analyzer system according to the invention.

FIG. 60 is a representation of a computer screen that might be presented to a user by a process analyzer system according to the invention.

FIG. 61 is a representation of a computer screen that might be presented to a user by a process analyzer system according to the invention.

FIG. 62 is a representation of a computer screen that might be presented to a user by a process analyzer system according to the invention.

FIG. 63 is a representation of an active process list that might be presented to a user upon request for active processes.

FIG. 64 is a representation of a display that might be presented to a user upon a request for more detail as to the status of a particular active process.

FIG. 65 is a representation of a list of process milestones that might be presented to a user upon request for status of a particular process.

FIG. 66 is a representation of a graphical display that might be presented to a user to illustrate statistics relating to various processes.

FIG. 67 is a representation of a different graphical display that might be presented to a user to illustrate statistics relating to various processes.

### DETAILED DESCRIPTION OF THE INVENTION

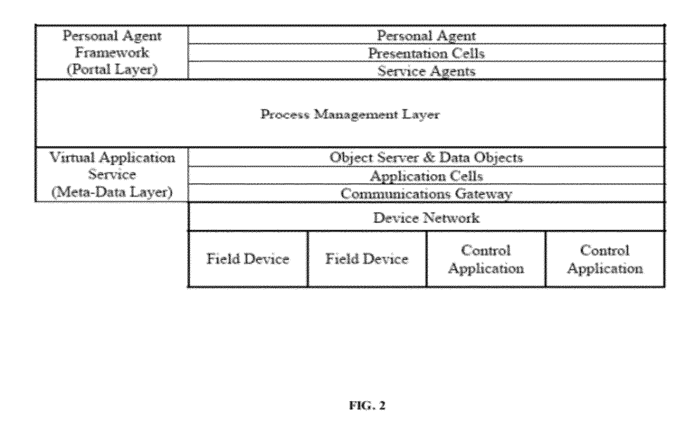

FIG. 2 shows a system according to the invention in which the process management system of the invention resides between the portal layer and the meta data layer of a SCADA system. Field devices, control applications and enterprise applications constitute the device and application layer. Data and information from various and diverse field devices and control applications are represented at the meta data layer of a SCADA system according to known methods and systems. According to the invention, data and information from various enterprise applications are also represented at the meta data layer of a SCADA system. The portal layer includes applications and interfaces for logging onto and accessing the SCADA system, once again according to known methods and systems. However, where, according to the prior art, a user would use the portal layer to monitor, query, and command each device and application separately, the present invention provides a process management layer which comprises an interface module which communicates with the portal layer, a process configuration module which an end user accesses via the interface module and which guides the user through device selection and response process configuration, and which stores the configured process and which executes process launch and process monitoring when there is a particular status change, event or transaction at a field device or control or enterprise application at the device and application layer.

In particular, the present invention also includes a process analyzer module which allows a user to access a configured process, to define process measurements at various locations in the process diagram, and to view various analyses of collective instances of the process based on the defined measurements using data collected from devices, systems and applications and saved, for example, in a SCADA system.

System access and process configuration by an end user, as well as process launch and execution upon a status or event trigger is explained in U.S. application Ser. No. 12/952,6745, the entirety of which is incorporated herein by reference.

User access of a previously configured process definition, setting of process measurement definitions, and viewing and modification of various process analyses can be explained by way of example.

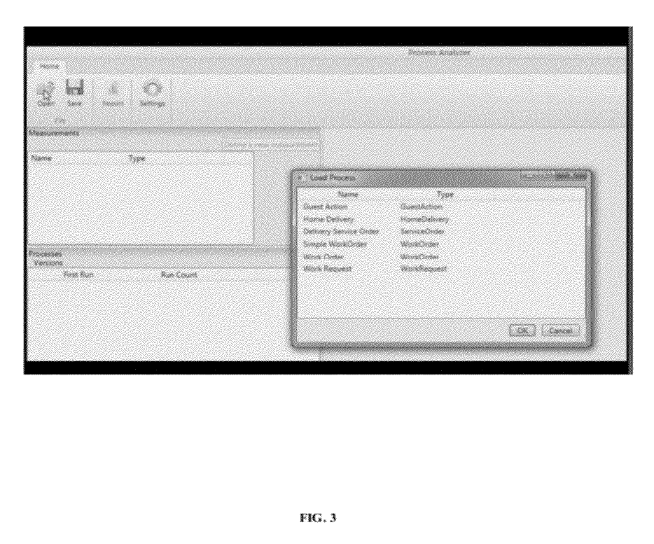

Practice of the process analyzer aspect of the invention begins with launching of the process analyzer module. The user then selects the “open” icon to obtain a list of available processes for analysis. FIG. 3 shows an exemplary list of available processes that may be loaded into the process analyzer, including “Guest Action”, “Home Delivery”, “Delivery Service Order”, “Simple WorkOrder”, “Work Order”, and “Work Request.” According to a preferred embodiment, the available processes have been previously defined, configured, and deployed in the system according to the steps set forth in U.S. application Ser. No. 12/952,675, filed Dec. 23, 2010, the entirety of which is incorporated herein by reference. The user selects a process for loading into the analyzer and then clicks “ok.”

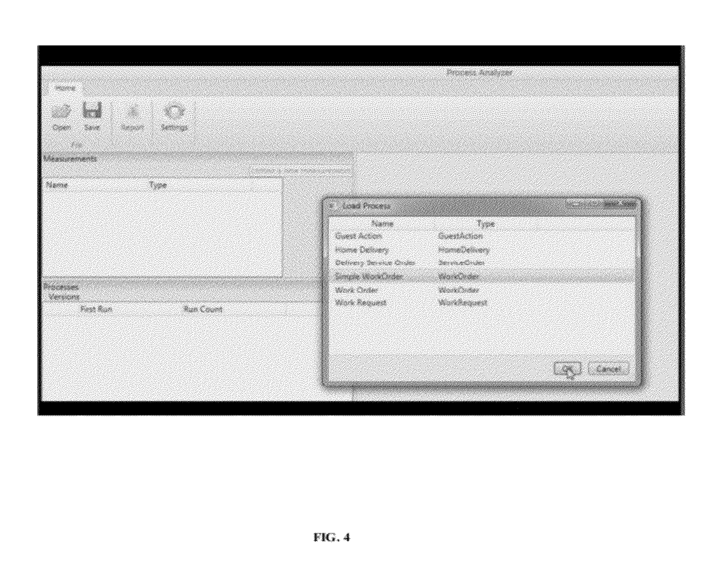

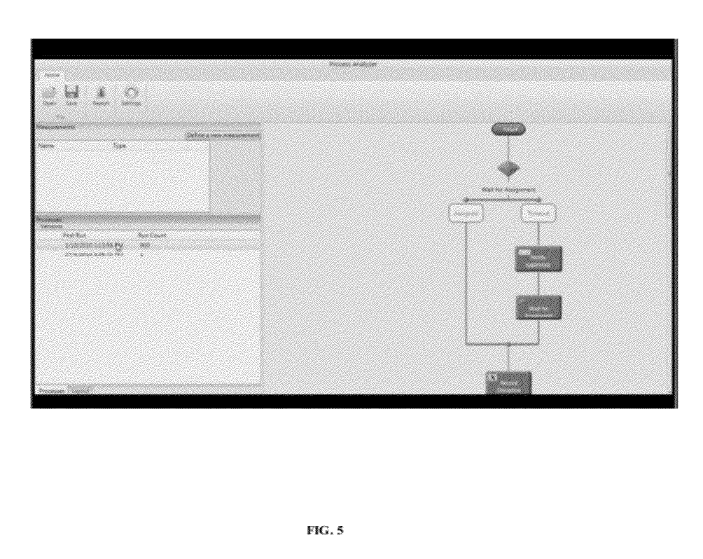

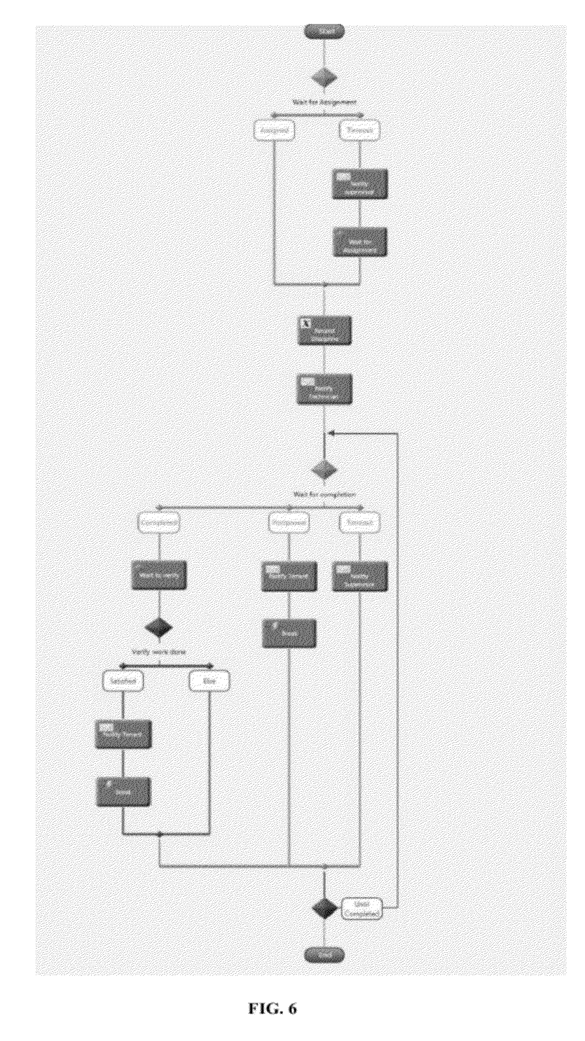

FIG. 4 is a representation of a screen showing a user having clicked and highlighted on “Simple WorkOrder” for selection and ready to click “OK.” FIG. 5 shows a representation of screen in which a user has selected diagram for the process definition for the process “Simple WorkOrder” that might be presented in a next screen if a user selected the “Simple WorkOrder” process from the list of processes shown in FIGS. 3 and 4. This Process Measurement Editor thus allows identification and opening of any process template registered in the system. The user can then define the measurements and checkpoints, attach the measurement locations or “tabs,” to each version of the process template and store it back in the system. FIG. 6 is a diagram of the entire Simple WorkOrder process definition, a portion of which is shown in FIG. 5.

At the left hand side of FIG. 5, two versions of the Simple WorkOrder process definition are listed, an older version with a run count of 1, and a newer version with a run count of 900. Run count is the number of times that that process version has been carried out in actual instance.

In the prior art, process measurements had to be defined during process configuration, and process configuration was not editable. According to this invention, process measurements can be defined after the process has been deployed and data collected. Moreover, since the process definition is editable, multiple versions of processes may exist, and each version may be configured for measurement and included in any analysis, if desired. In short, it is possible the current version of the process template may have been modified one or more times in the past. In this case, process instances in the history tables might belong to more than one versions of the process template. Thus, when the process template is downloaded and opened, the process measurement editor also shows available different versions of the process template in the history tables.

The next step according to the invention is to define one or more process parameters for analysis. There are three types of parameters used for analyzing process data: process variables, checkpoints and measurements.

Process variables are defined at the time of configuring the process template. Process variables cannot be added after a process is deployed to run except as a new version of the template. The primary role of process variables in process analysis is to allow classification of process instances into various groups. For example, in work order process, we may save “technician” as a process variable, which will allow analysis of time-to-complete by each technician.

Checkpoints are points in the process that are critical to track to understand the progress of each process instance. In process analysis, checkpoints can be used to classify the process instances when defining the sample space. For example, analyzing of “time to complete a WO where spare parts were not found in stock” requires a checkpoint to determine whether parts are found in stock or not. Checkpoints can be defined after a process is deployed to run and can be applied to both past and future process instances.

Measurements are analogue values, and they are two kinds: “loop count” and “duration” between two stages in the process. Similar to checkpoints, measurements can also be defined after a process is deployed to run.

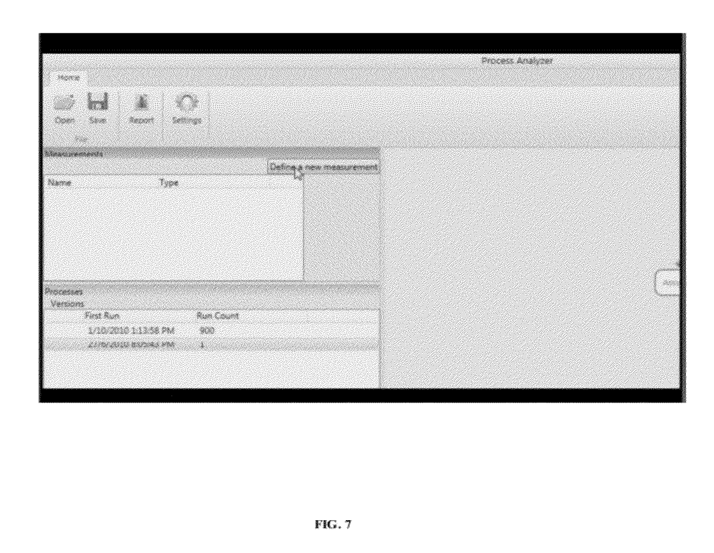

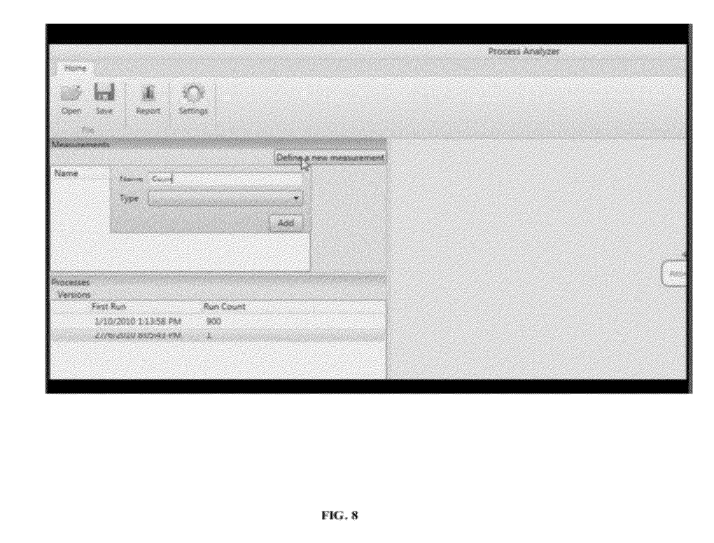

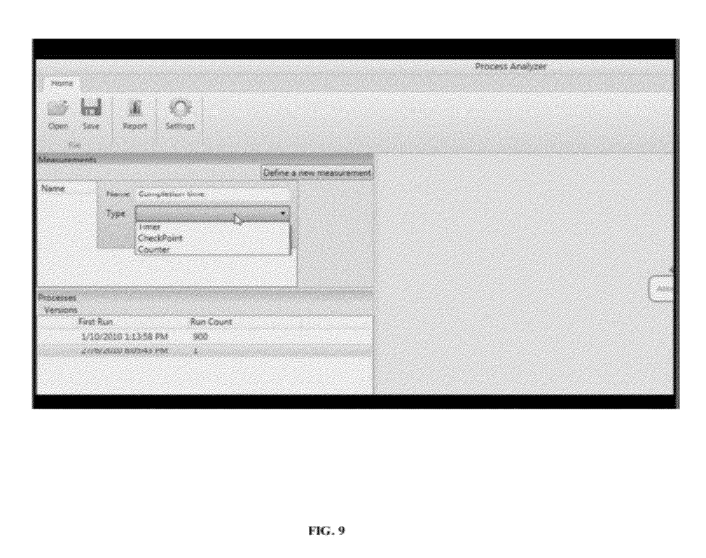

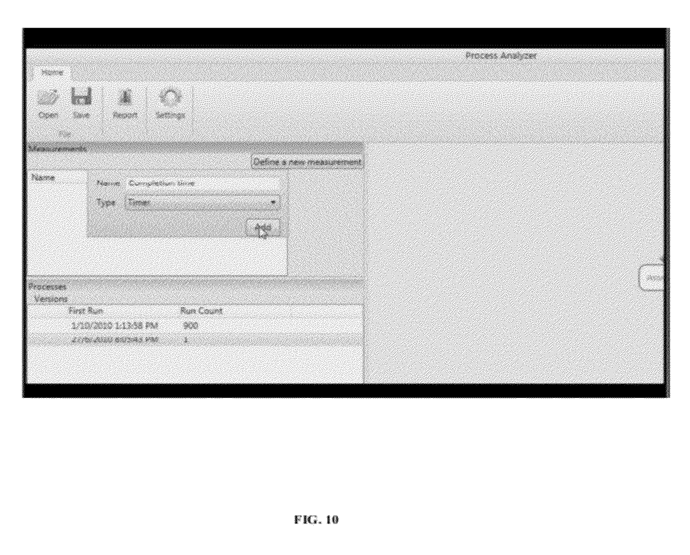

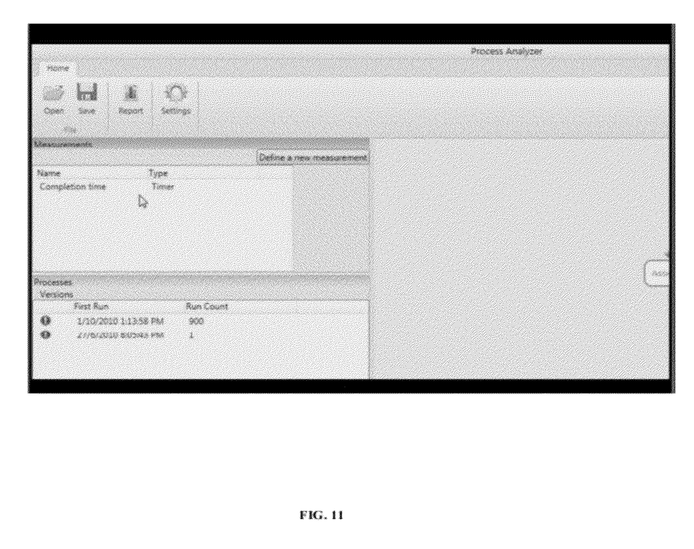

According to this example, the measurement will be overall completion time for the process. To do this, the user selects “define a new measurement” under the “Measurement” section displayed on the screen shown in FIG. 7, and the user is prompted to enter a measurement name and to select a measurement type. FIG. 8 shows a user having selected “Define a New Measurement” and being presented with a dialog box for entry, starting to enter a measurement name, complete with typographical error. FIG. 9 shows the user selecting the type of measurement from a pull down menu with available measurement types as “timer”, “checkpoint” and “counter.” FIG. 10 shows the user having selected Timer as the measurement type and ready to click “add” to complete the new measurement definition. FIG. 11 shows the new “Completion time” measurement in the Measurement box of the Process Measurement Editor.

When a process template is opened, the Process Measurement Editor will show the list of measurements and checkpoints defined for the selected business process in the “Measurement” box. For system to work correctly, these measurements must be attached, or “tabbed,” to the process definition at appropriate stages. If any of the versions have unassigned measurement tabs, the process measurement editor will bring it to user's attention.

When a new checkpoint or a measurement is added, corresponding tabs should be attached to all versions of the process template. In an event where newly placed measurement is not applicable to old versions of the process template, it can be marked as “not applicable” to avoid editor highlighting it as an error.

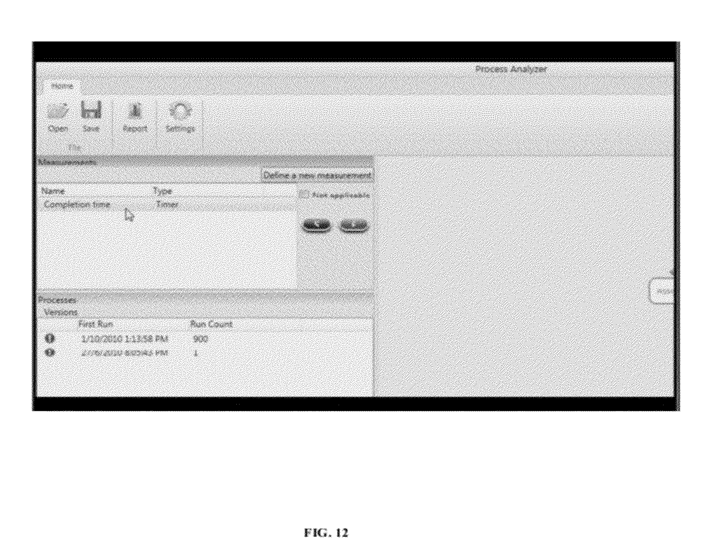

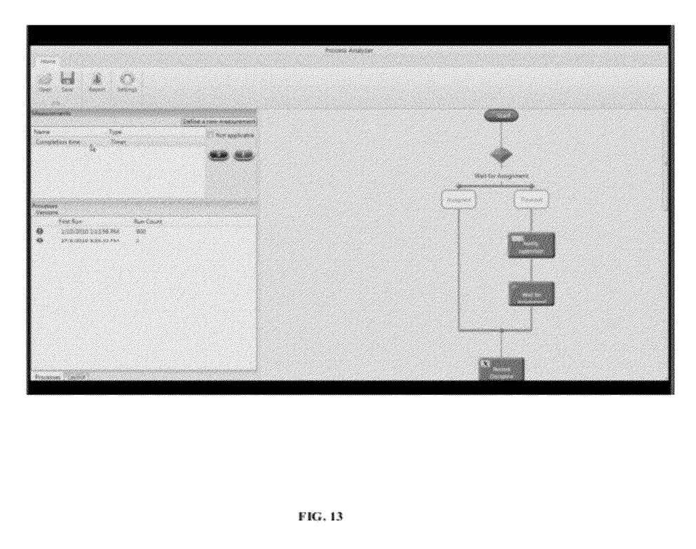

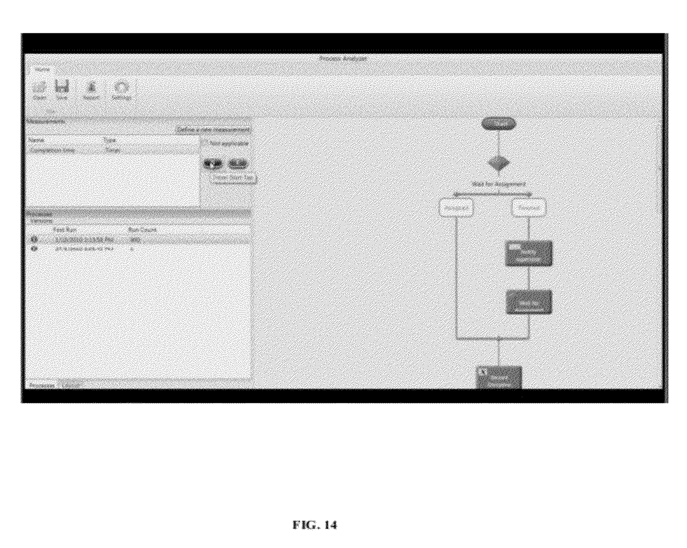

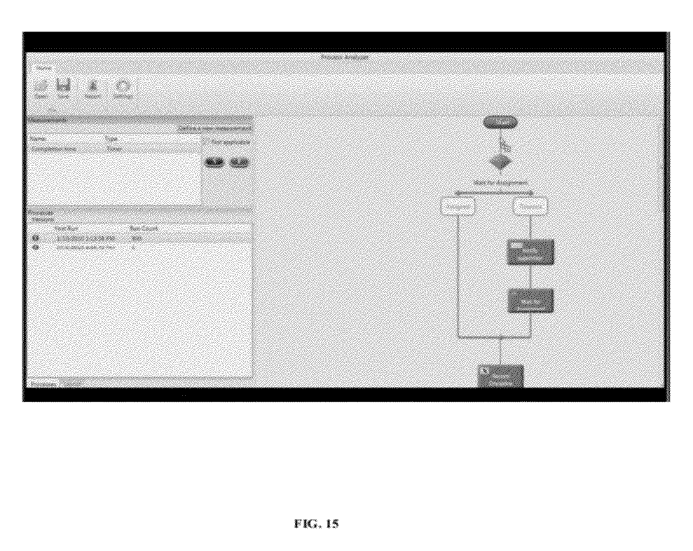

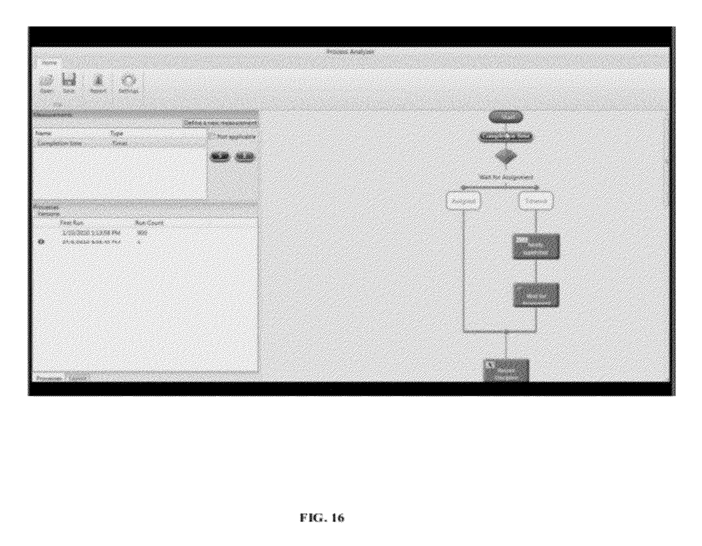

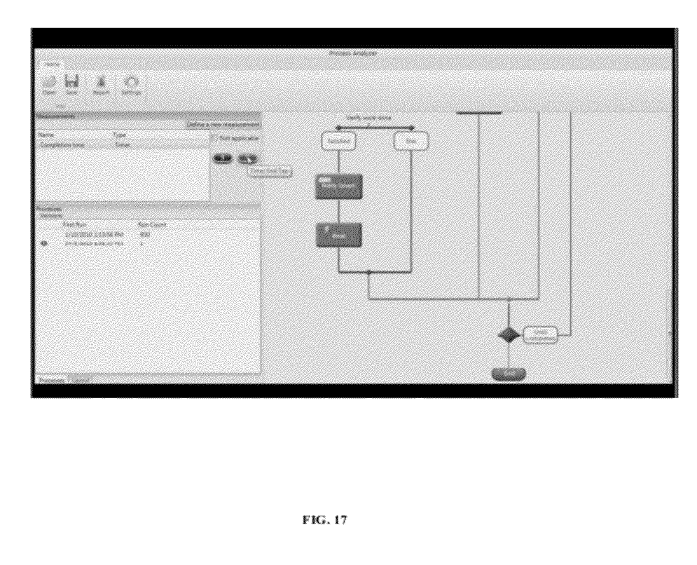

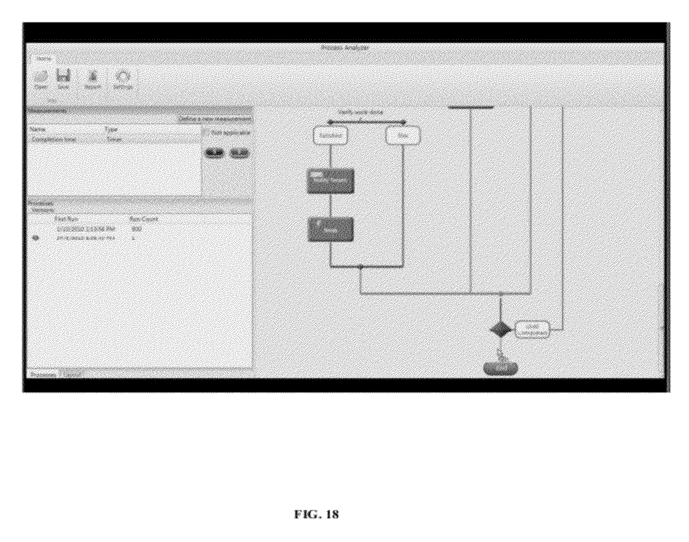

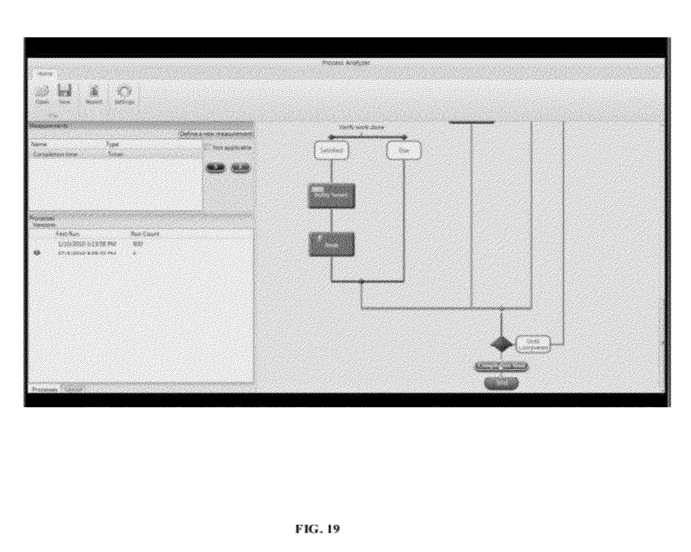

FIGS. 12 and 13 shows a user having selected the “Completion time” measurement and being presented with measurement location tabs “S” and “E” representing Start and End points for the desired timer. To place the Start tab, the user selects the Start tab (FIG. 14), then moves the cursor to a location on the process diagram where the user would like to start the time (FIG. 15). FIG. 16 shows the completion timer start tab as having been placed by the user on the process diagram between process Start and “wait for assignment.” The End tab is placed in a similar fashion (FIGS. 17-19). The system will prompt the user to define the measurement for each version of the process, or to select “not applicable” if the user does not wish to configure one or more versions for analysis.

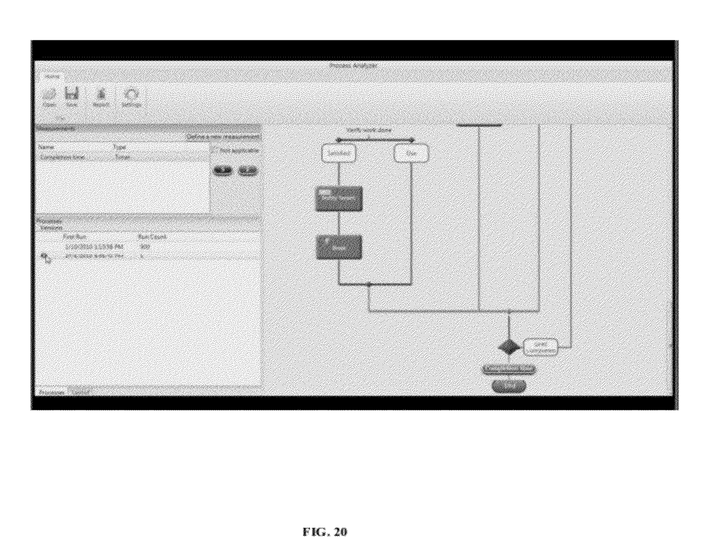

If the measurement location tabs for a selected measurement have not been set for a version of the process, the system will present an exclamation point next to the version of the process for which the location tabs have not been set, see, e.g., FIG. 20. To set the location tabs of the version for which they have not been set, the user selects the version in the process version box, shown e.g., in FIG. 20, and then sets the measurement location tabs for that process version in the same way as described above.

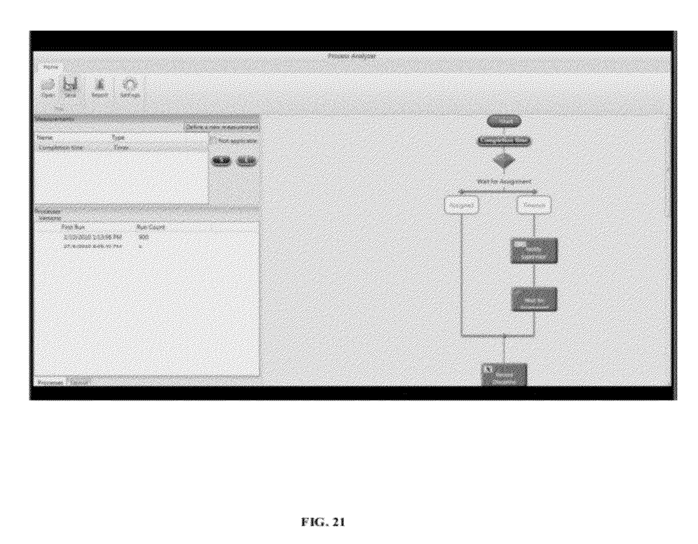

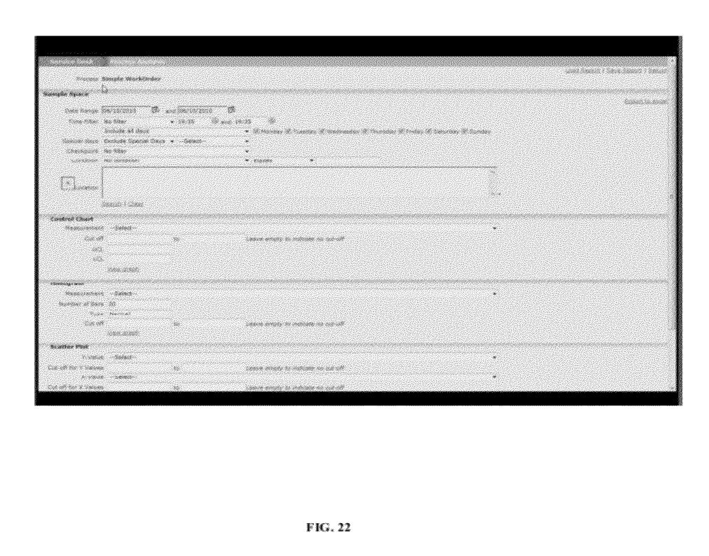

Once the completion time measurement configuration has been completed, the user saves the measurement configuration to the system by selecting the “save” tab (FIG. 21). In order to view the available analysis using the completion time measurement, the user selects the “reports” tab in the process analyzer module. FIG. 22 shows an example of a screen that might be presented to a user having configured and saved a completion time measurement in the Simple WorkOrder process, and then having selected the “reports” tab.

According to a preferred embodiment of the invention, when the process analysis screen (FIG. 22) is presented to the user having selected the “reports” tab, the user may define a sample space by selecting start and end dates and times, and, if desired, various filters to select specific time periods (e.g., holidays, weekends, daytime, nighttime) for analysis or exclusion. In addition, when the process template is selected, the system will check the history for existence of multiple triggers, and will indicate it to user. At that point, user may select a single trigger, or ignore the trigger (i.e.: consider all).

The user may also filter the sample space by selecting a process variable matching or not matching a specified value, by selecting one or more checkpoints (discussed below) and/or other analysis conditions. The user can also define a specific process location for analysis. Since every process has one or more associated locations (actual devices or space locations, e.g., “lobby,” “cafeteria,” etc.), the user can limit the process analysis to specific locations, if desired.

Once the user has set the sample space for analysis, the user may be presented with a selection with analysis tools. The system can be configured to offer the user any of a variety of data analyses and graphical presentations. Representative available analyses include a control chart, a histogram, and a scatter plot. For any particular analysis, further settings may necessary. Whatever analysis is selected by the user, the user may have the option to switch between different analyses without having to redefine the sample space.

The objective of a control chart is to see whether process instances are staying within acceptable levels. For this analysis, a process measurement should be selected, which will appear in y-axis. X-axis is time, showing the full span of selected range. The user can also define CL, LCL & UCL to (visually) see whether the data falls within acceptable limits.

The objective of a histogram is to compare the frequency of process instances falling into various ranges (of a selected process measurement). For this analysis, a process measurement should be selected, which appears in the x-axis. The user will be able to modify the number of groups in x-axis for better visibility of the curve. The Y-axis is the count of number of process instances. The histogram chart can be set to a default according to which the x-axis scale reflects the six-sigma range, which can be modified to get a better view of the distribution curve.

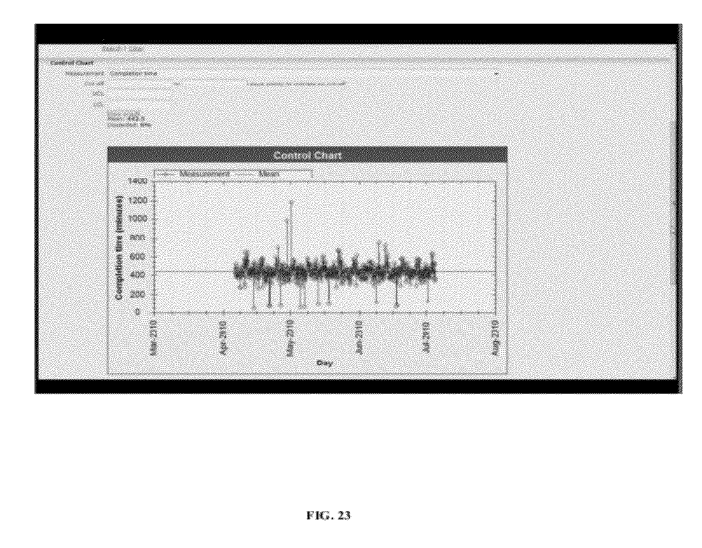

FIG. 23 shows a representative presentation of a control chart showing completion time measurement (selected in the measurement “field under Control Chart”) for the Simple WorkOrder process. This control chart shows completion time of all instances of the Simple WorkOrder process that took place over the date and time ranges that were set for the sample space. As can be seen from FIG. 23, a number of instances of the Simple WorkOrder process took much longer than the average. The process analysis system of the invention can be used to analyze processes to see if the cause of outlying data can be determined.

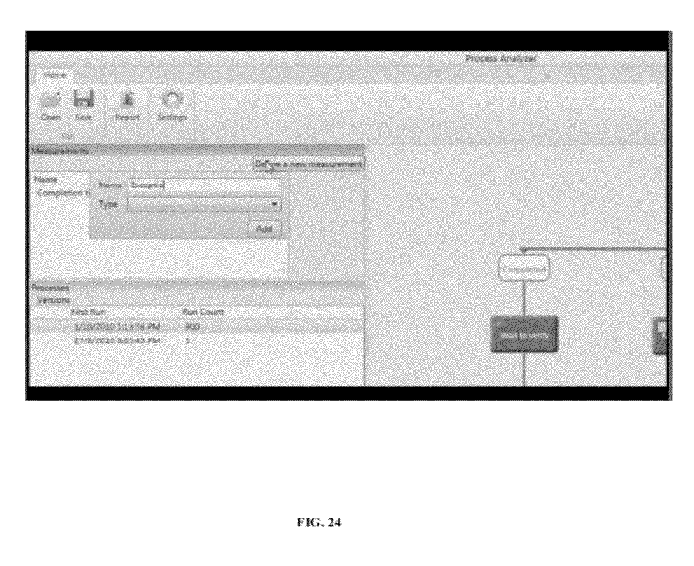

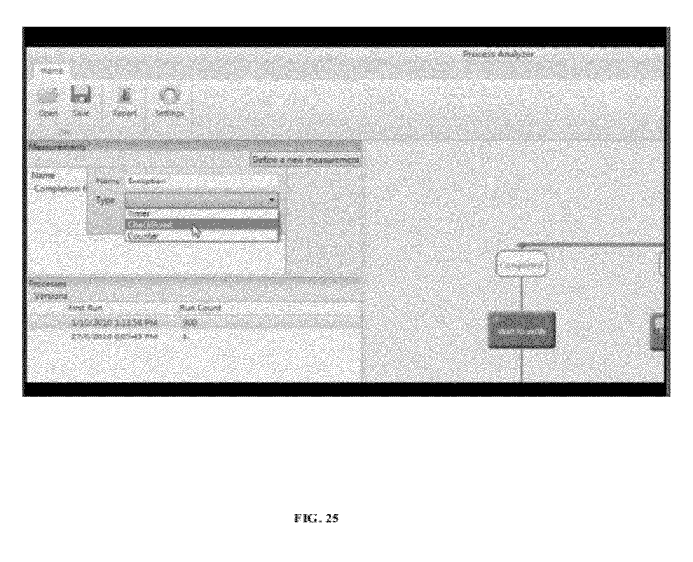

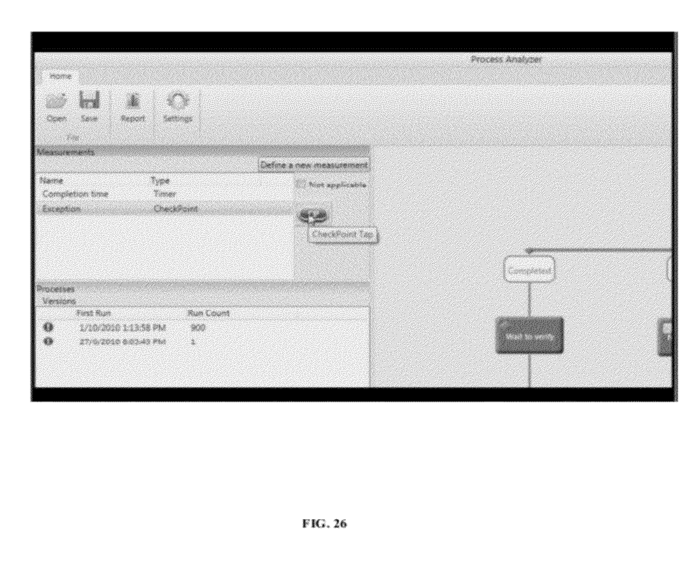

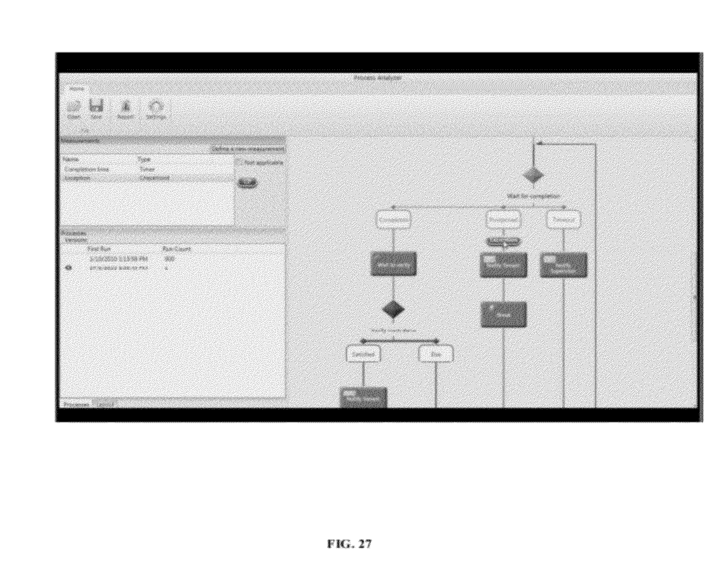

Returning to the process definition for Simple WorkOrder (FIG. 6), the user will notice that between start and completion time, there is a “postponed” loop, the data for which was included in the completion time measurement and analysis shown in FIG. 23. However, if the work was postponed, it was therefore not undertaken and should not have been included in the completion time analysis. To remove this scenario from the analysis, the user may define a new measurement, which in FIG. 24, the user is shown naming “Exception.” In FIG. 25, the user is shown selecting “checkpoint” as the measurement type from the pull-down menu. The new measurement having been defined, FIG. 26 shows the user having selected the new Exception measurement in the Measurement box, and being presented with the measurement location tab “CP.” FIG. 27 shows the user placing the checkpoint location measurement tab just under “postponed” on the process definition. Since both versions of the process are being included in the analysis, the checkpoint should be set for both version of the process.

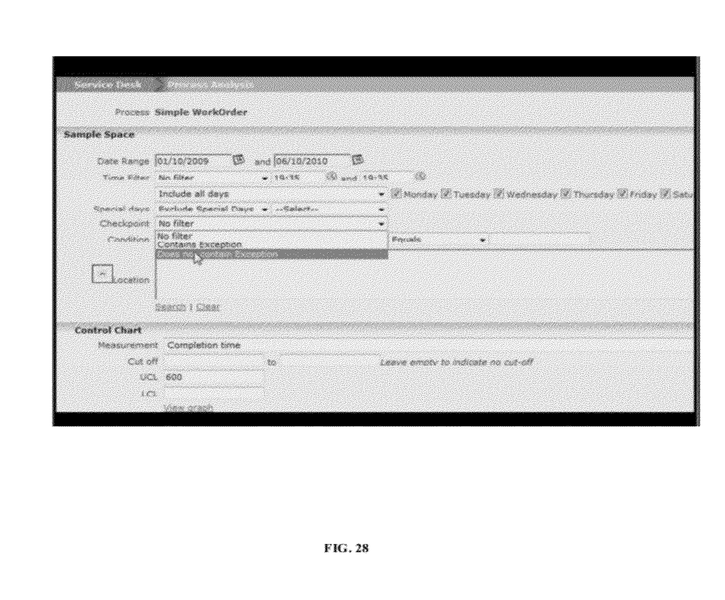

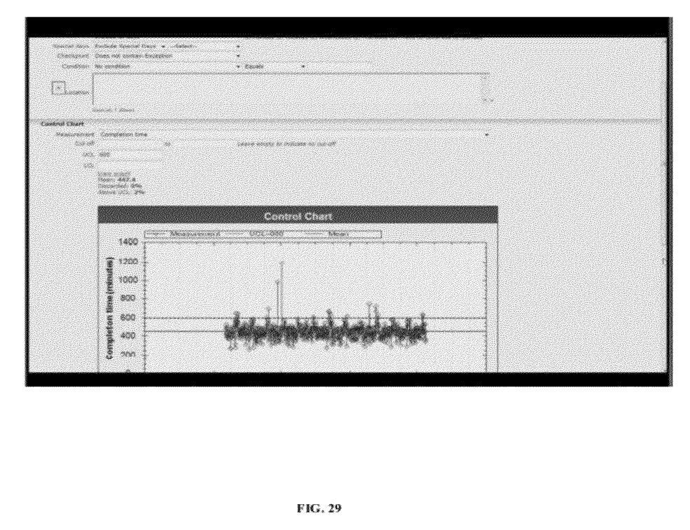

Once the exception for the postponed loop has been set, the user can select the report” tab again to return to the analysis page. To exclude the postponed loop from the completion time analysis, the user may use a pull down menu in the Checkpoint field to select “does not contain exception,” as shown in FIG. 28. The user can then select “view graph” under Control Chart to view the analysis (FIG. 29) with the postponed loop removed.

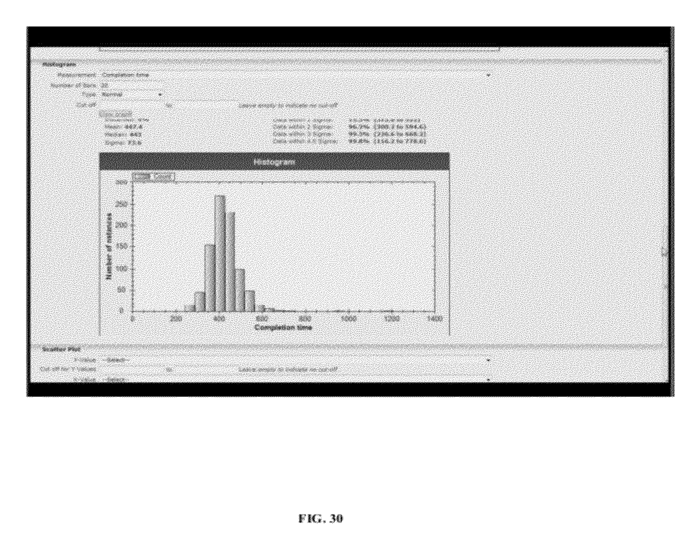

FIG. 30 shows a histogram that groups the process instances by completion time. This histogram may be accessed by selecting the view graph button under the Histogram heading.

The analyses available according to the present invention may be used for Six Sigma analysis because, unlike prior art systems, it allows the user to exclude non-random data from the analysis. Prior art systems do not have this capability because process automation is accomplished through hard-coded binding between different applications, rather than the flexible and user-editable process automation between different systems and applications of the present invention, and because, in the prior art, process automation and process monitoring and/or analysis are conducted in separate and independent applications. In the present invention, however, both process automation and process monitoring, even between multiple systems and applications, are fully configurable and editable by the end user, and they are fully integrated with one-another.

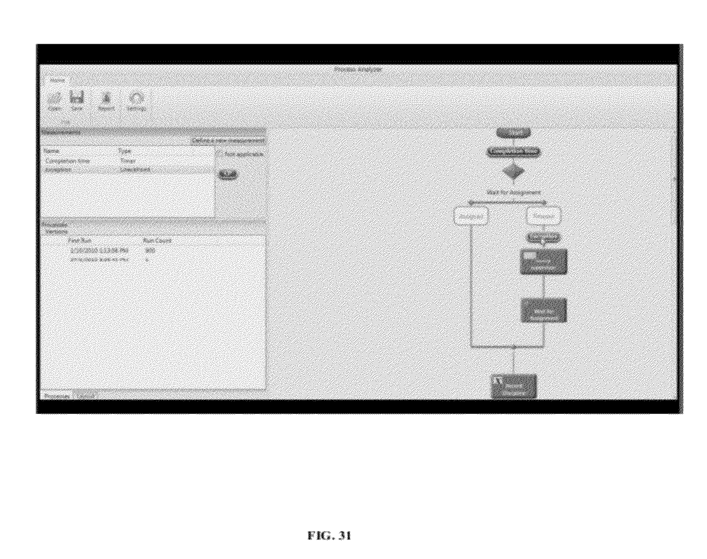

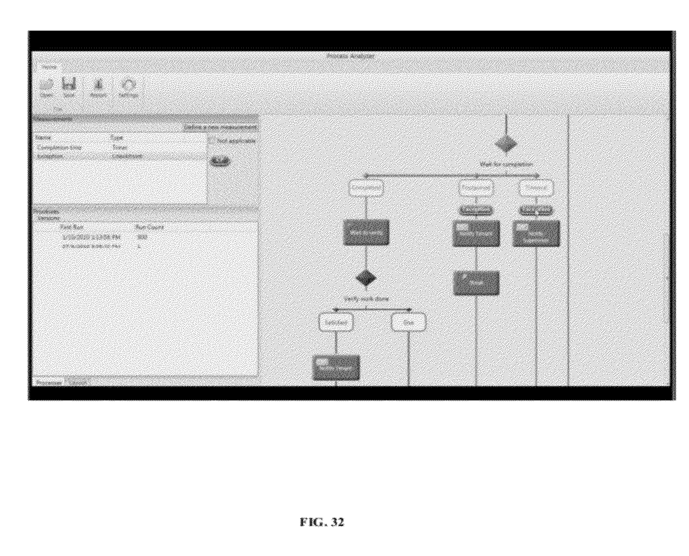

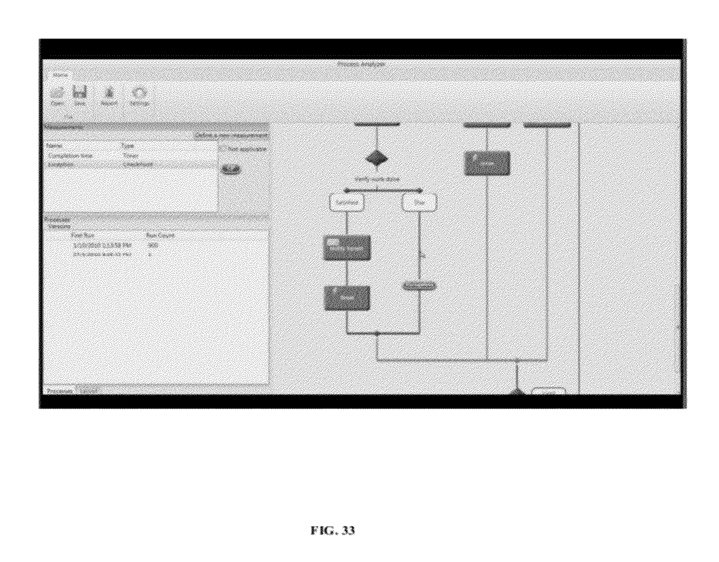

Accordingly, to conduct Sigma-Six analysis of completion time using the present invention for example, the process definition can be examined to determine if the events leading to completion time are randomly distributed. Returning to the process definition for Simple WorkOrder, it can be seen that the process includes provisions for handling anomalous instances of the process. For example, there are timeouts when the assignment is not made within a specified time period and the supervisor is notified. When the process includes such instances, the process is no longer random. In order to remove these non-random instances from the data analysis, the user may return to the Process Measurement Editor. Selecting the Simple WorkOrder process, the user may insert additional exception tabs for the two timeout loops in the Simple WorkOrder process definition as shown in FIGS. 31 and 32. Additionally, the user may insert an exception tab where the work verification was not satisfactory as shown in FIG. 33, because this is another non-random variation in the process.

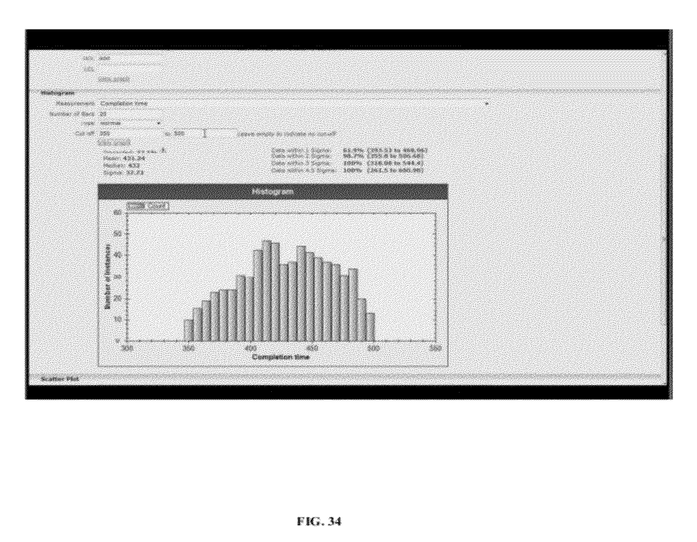

Once these additional exceptions are added, the reports may be run again, excluding the exceptions. As shown in FIG. 34, the remaining iterations of the process meet Six Sigma.

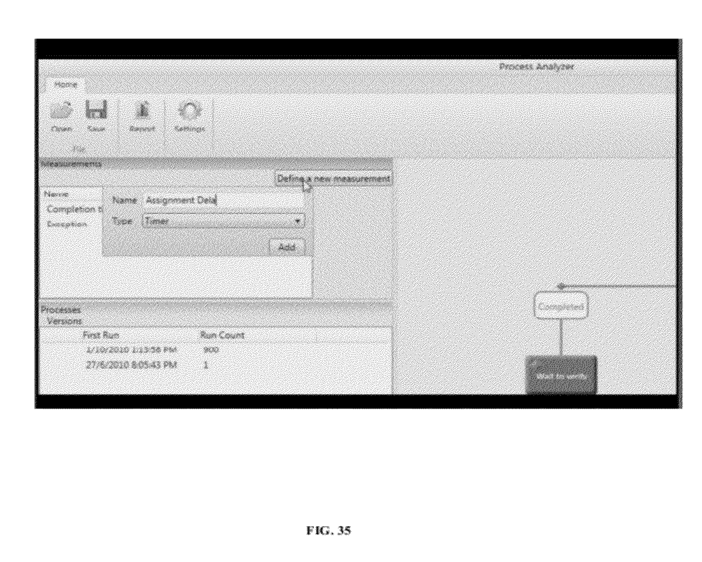

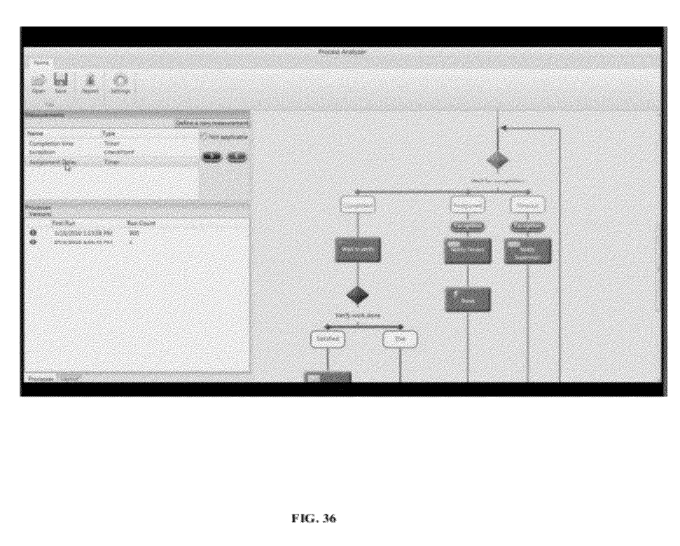

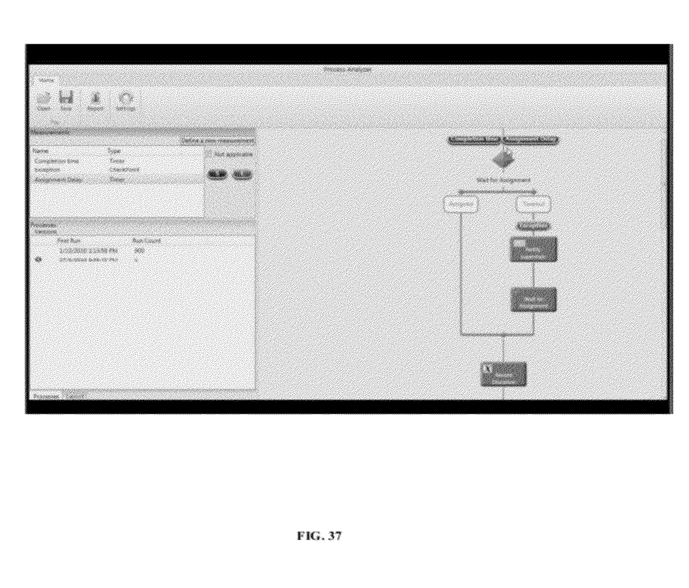

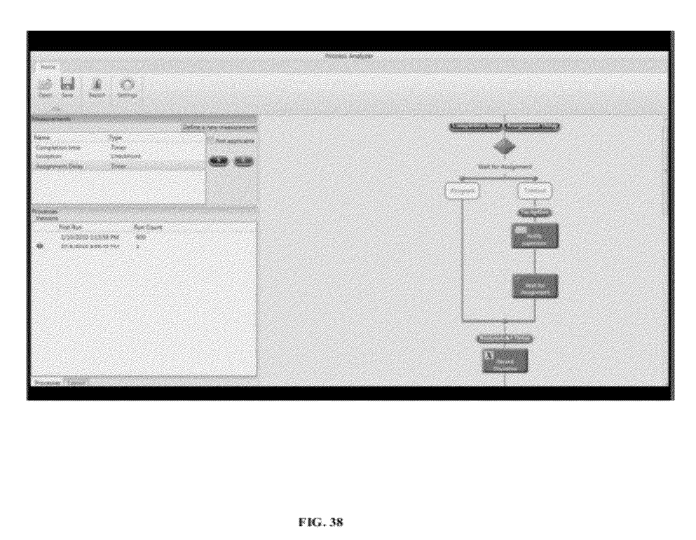

Review of the process definition for the Simple WorkOrder process reveals two key delays: assignment delay, and wait-for-completion delay. To measure the actual delay resulting from these steps, the user may define new measurements in the Process Measurement Editor, as shown in FIG. 35. FIG. 36 shows a user having defined a new measurement entitled “Assignment delay” and selected it as a timer measurement. FIG. 37 shows the user having set the Start tab in the process definition just before “wait for assignment,” and FIG. 38 shows the user having set the End tab just after the “assignment” block.

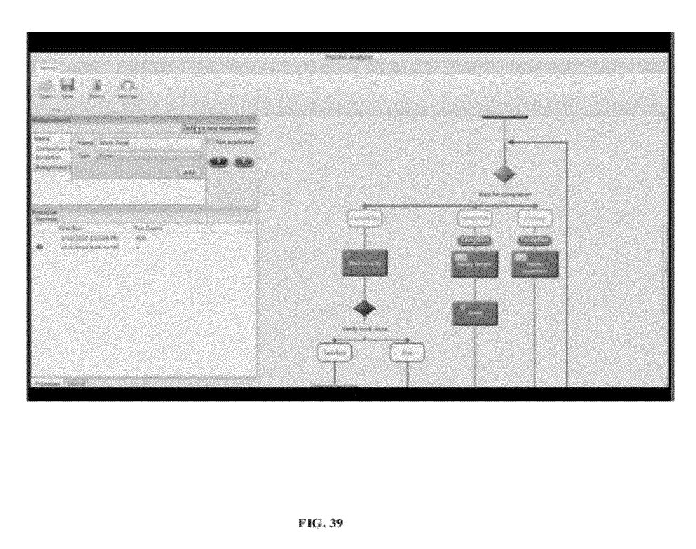

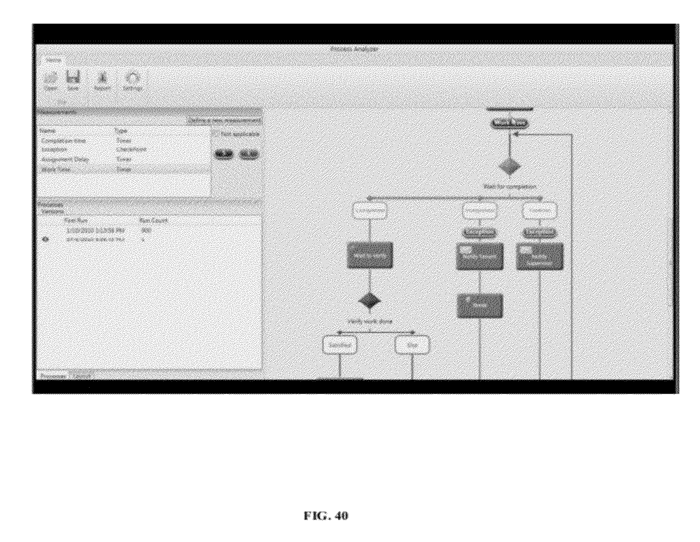

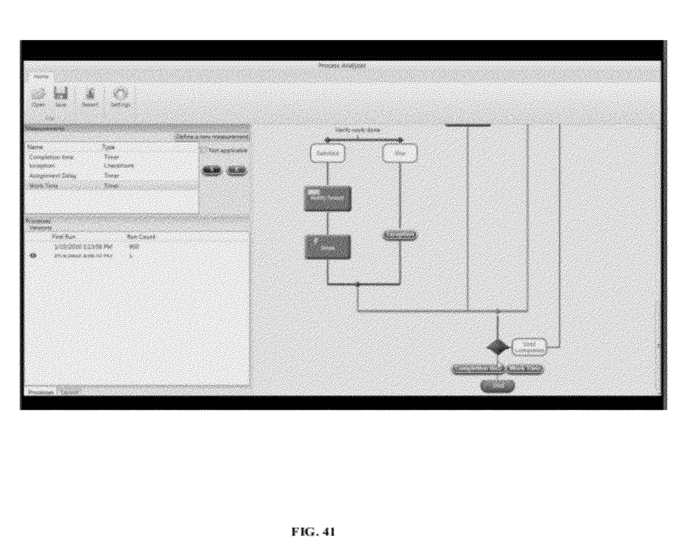

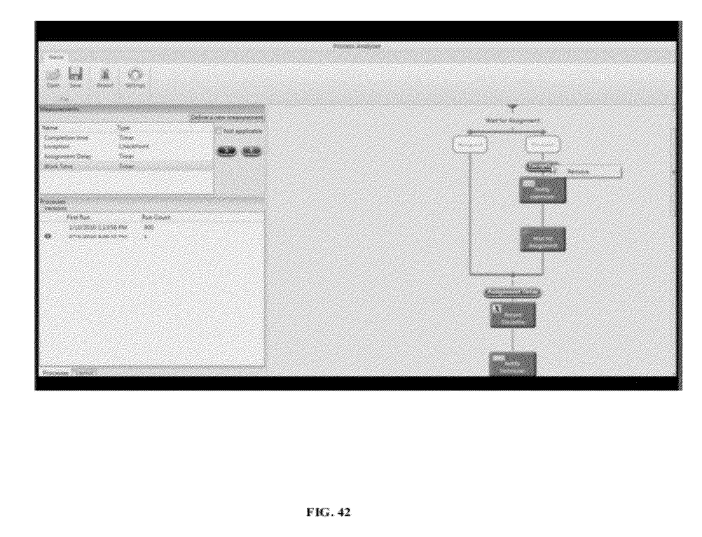

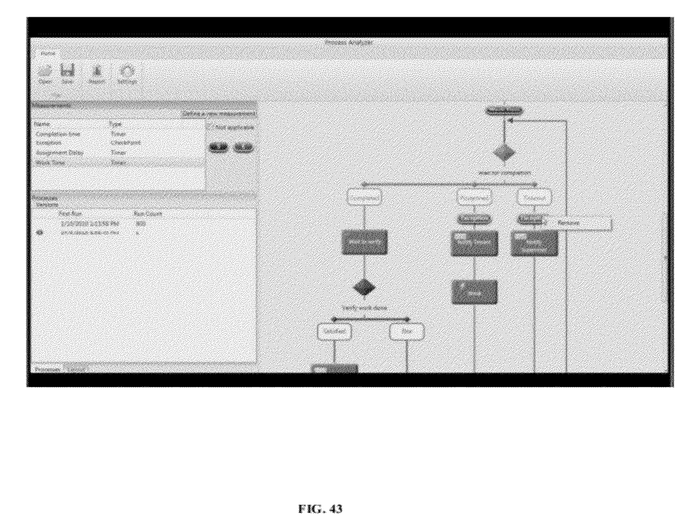

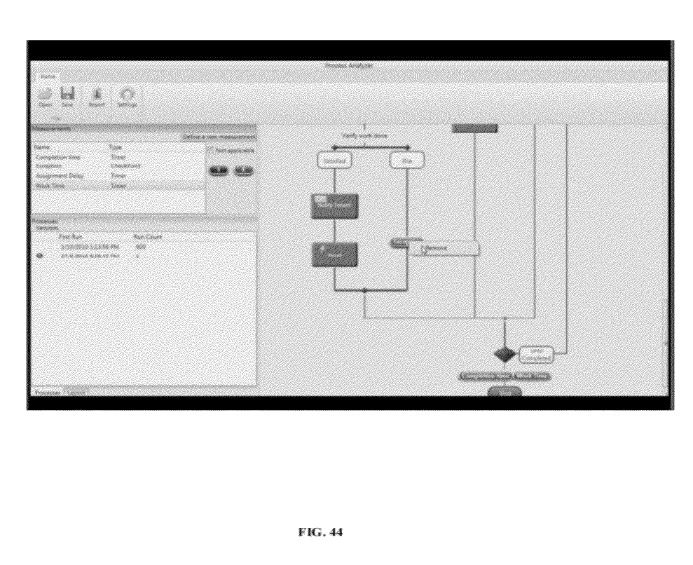

Likewise, the user may define a “work time” measurement, as shown in FIG. 39. FIG. 40 shows the start tab for the work time measurement being set before “wait for completion,” and FIG. 41 shows the end tab being set just before “End.” If the user wishes to examine the work time for all instances, he must remove the “Exception” tabs discussed above by scrolling over the tab, right clicking and selecting “Remove” as shown in FIGS. 42, 43 and 44.

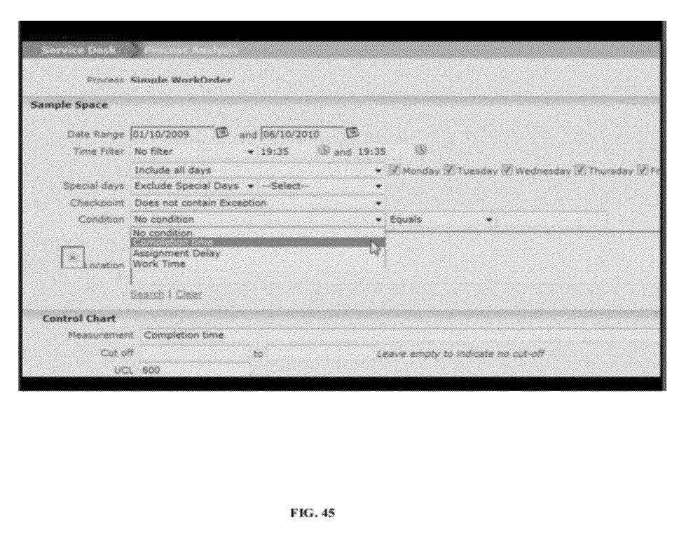

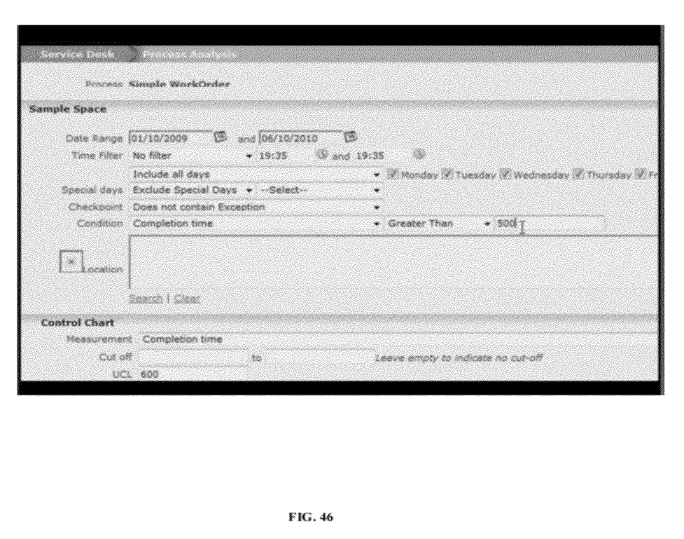

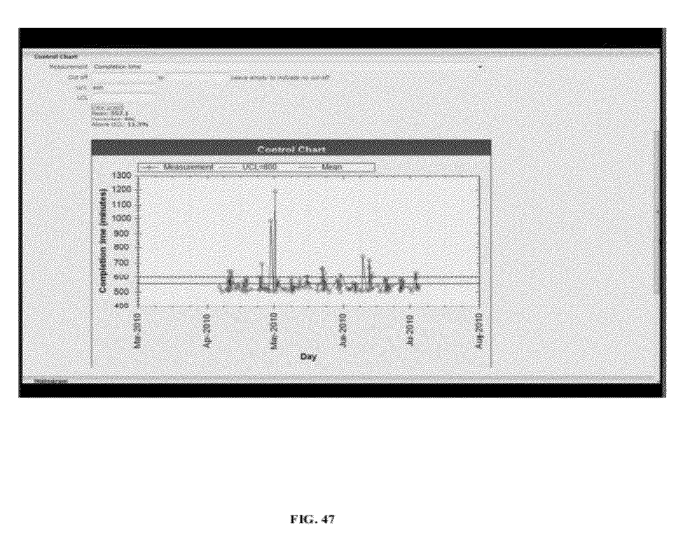

Returning to the Reports tab, the user can set the “Condition” to the “Completion Time” measurement from the pull down menu (FIG. 45), and if the user wishes to focus on the instances in which the completion time was greater than, for example, 500 minutes, the user may further set the condition time to completion time greater than 500 minutes as shown in FIG. 46. FIG. 47 shows a representative control chart showing instances of the Simple WorkOrder process that took over 500 minutes to complete.

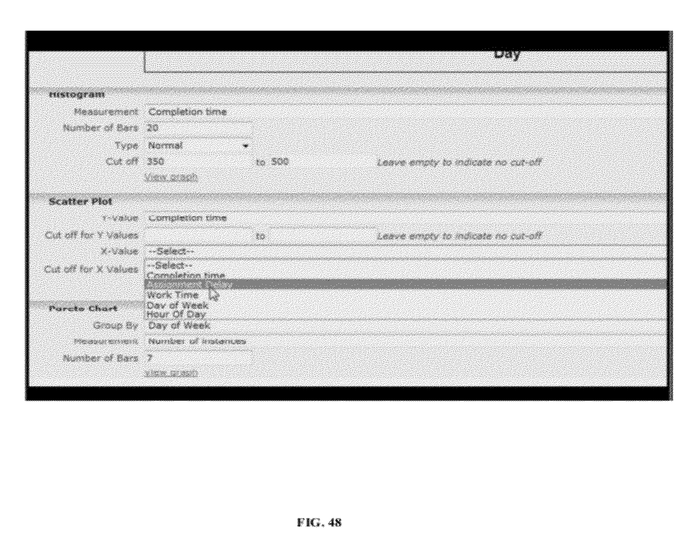

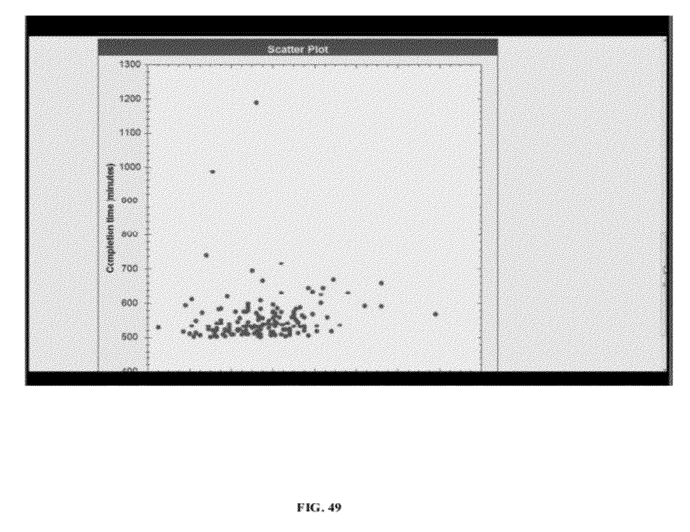

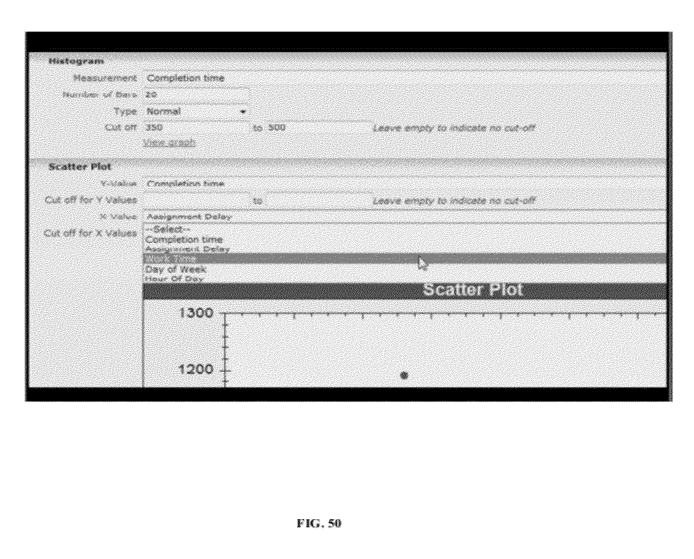

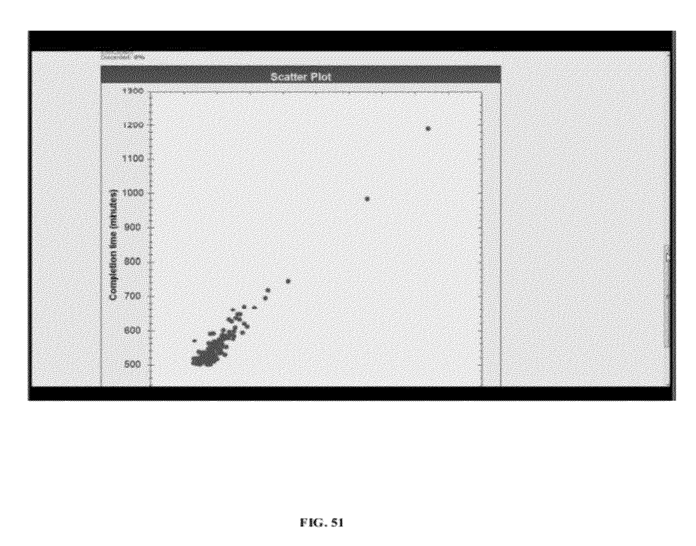

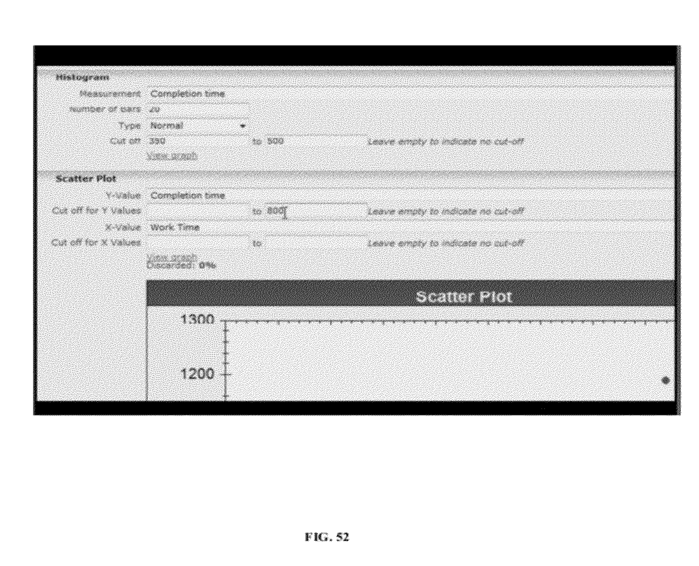

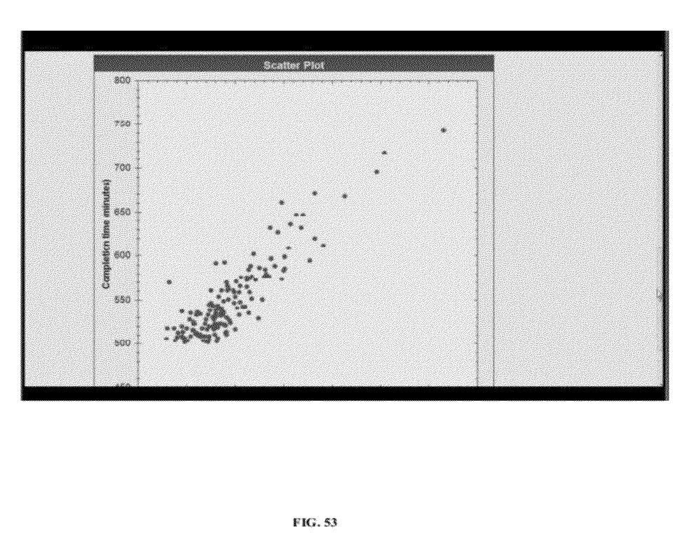

To determine whether the completion time has a relation, for example, to assignment delay, the scatter plot x and y values can be set to compare completion time to assignment delay as shown in FIG. 48. As shown in FIG. 49, the data for this example reflects a random distribution. To determine whether completion time has a relation to work time, for example, the x and y values of the scatter plot can be set to assignment delay and work time, respectively, as shown in FIG. 50. The corresponding scatter plot shows a relatively linear relationship (FIG. 51). To remove the outliers, the user can set a cut off value of, for example 800 minutes, as shown in FIG. 52. FIG. 53 shows a re-run of the scatter plot using the cutoff value. This figure shows that when work time increases, completion time also increases. Thus, using the foregoing analysis, the user can conclude that completion time is not attributable to assignment delay.

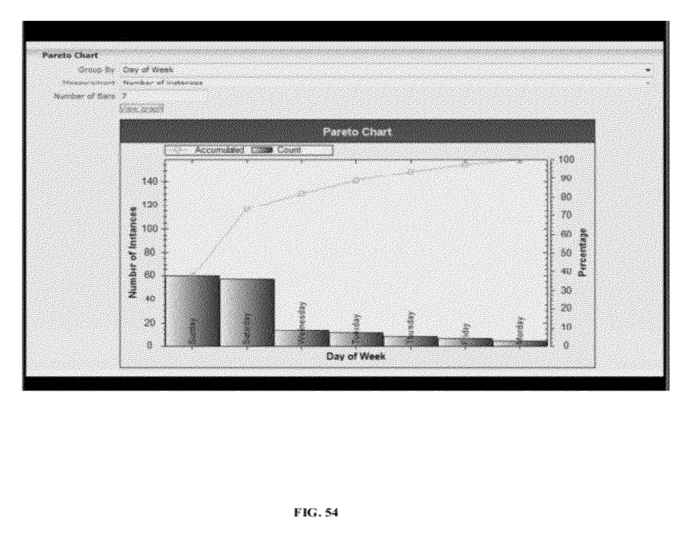

The Reports portion of the process analysis tool of the invention can be used to look at many other relationships. For example, a user can analyze set of records by day of week to see if there is any pattern that relates to the days of the week. Again, looking only at process instances over 500 minutes, FIG. 54 shows a Pareto chart grouping the number of process instances over 500 minutes by day of the week. As shown in FIG. 54, the problem is clearly Saturday and Sunday, which together contribute to 80% of process instances over 500 min.

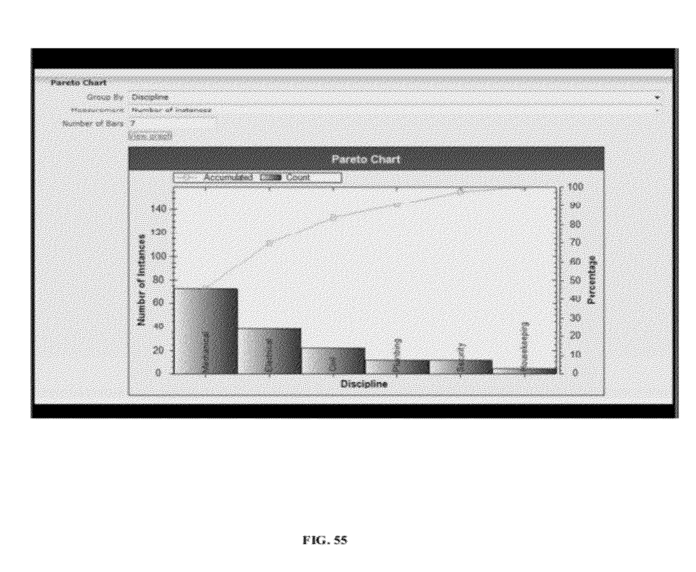

The user can also analyze process instances by discipline (e.g., mechanical, electrical, plumbing, etc.), as shown in FIG. 55. FIG. 55 shows that mechanical and electrical problems contribute most of cases over 500 min.

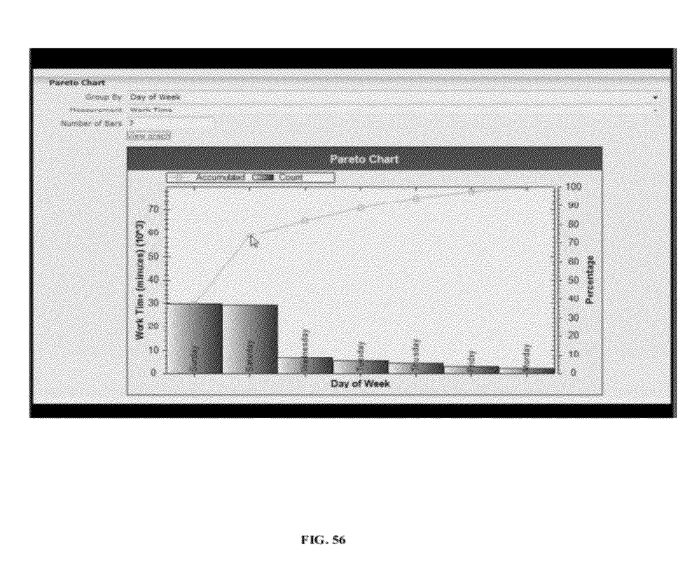

The process analysis tool can also be used to analyze work time by day of week, as shown in FIG. 56. FIG. 56 shows that work time is greater on Saturday and Sunday. Together, these analyses show that not only is the number of process instances over 500 minutes much higher on the weekend, but so is the work time.

A user might ask why the work time is higher on the weekend. It might simply be a scheduling or manpower issue. But the analysis described above also shows that there is some relation to discipline. The system may be used to conduct additional analyses to look further into the issue.

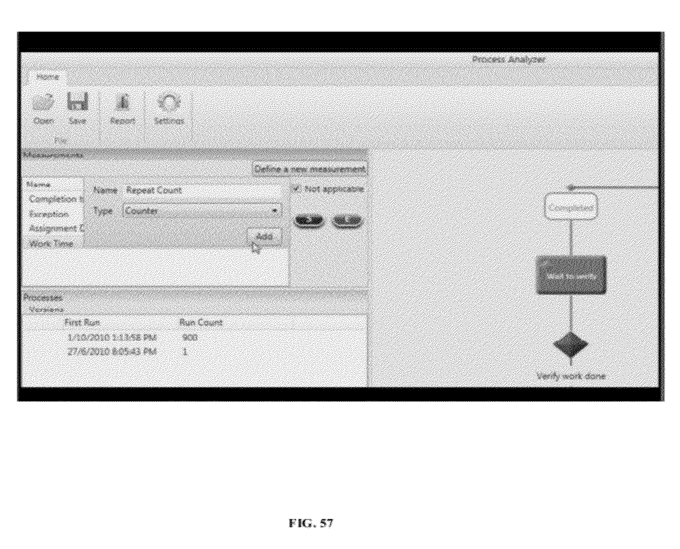

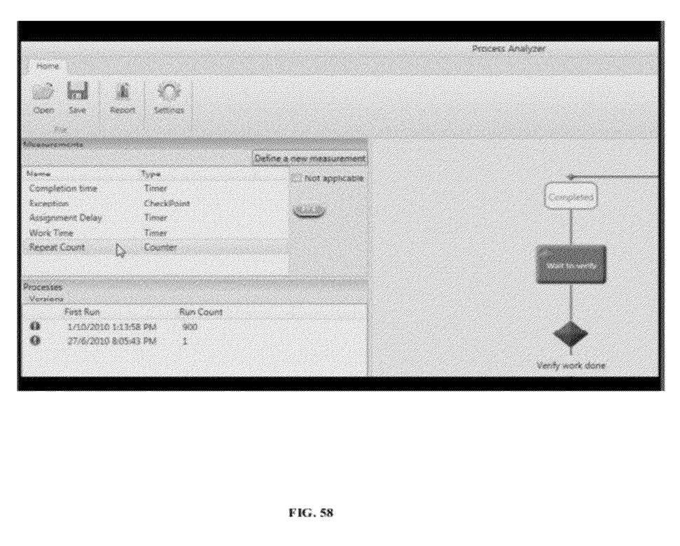

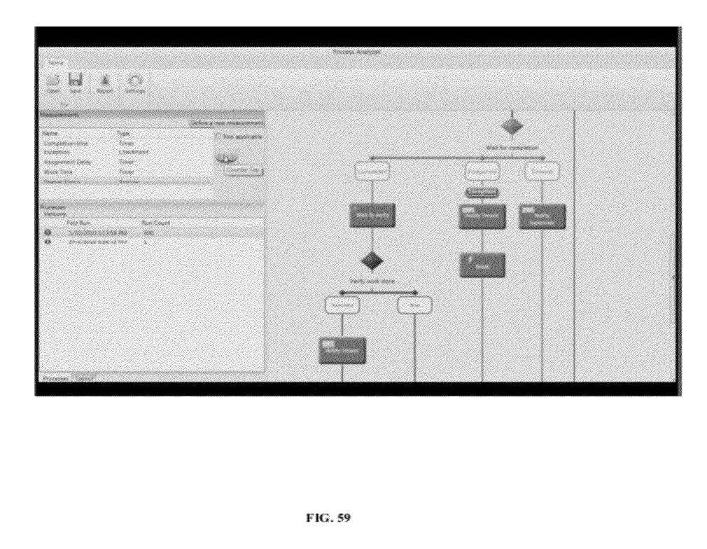

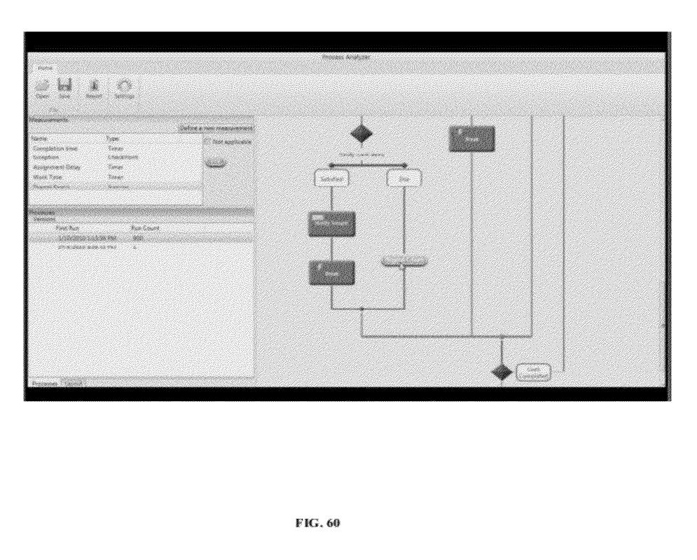

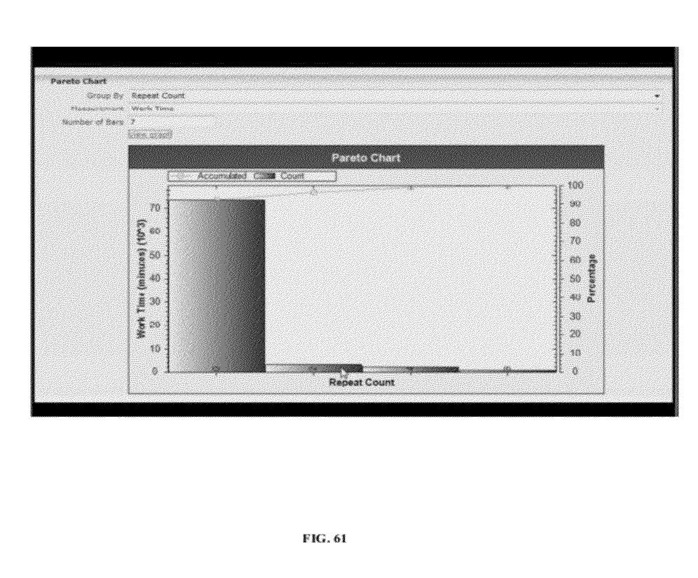

The process definition of the Simple WorkOrder includes several loops (see FIG. 6). To examine the effect of these loops on the process, the user may define new measurement in the Process Measurement Editor, which FIG. 57 shows the user identifying as “repeat count,” and selecting the measurement type as a counter. FIG. 58 shows the user selecting “Repeat Count” from the “Measurement” box, FIG. 59 shows the user clicking on the Repeat Count location tab (“Counter Tap” or “I+1”), and FIG. 60 shows the user placing the count location in the verification loop, the portion of the process in which the correct completion of the work is verified. Once the measurement has been set and saved, the user returns to the reports tab. The sample space is still set to completion time greater than 500. FIG. 61 shows a Pareto chart in which work time is grouped by Repeat count. The results show that repeat counts of 2, 3, and 4 only account for 10% of the instances of work time greater than 500 minutes.

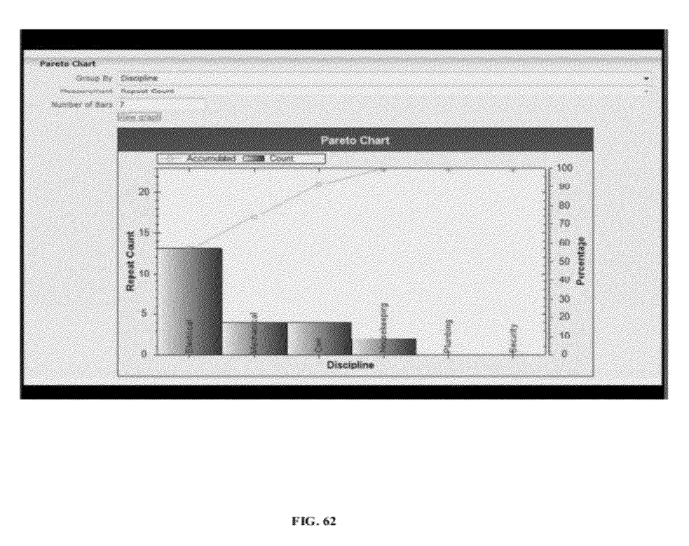

Examining repeat count instead by discipline, FIG. 62 shows that electrical work orders account for 60% of repeat count instances. This is not surprising. The correct completion of a mechanical, civil or housekeeping work order can often be easily determined and verified by sight. By contrast, when an electrical repair is needed, the repair must first be done, then it must be tested. If the test doesn't work, a different type of repair might have to be done, and then tested. The process continues until a positive test is obtained. Using the invention of the present invention, a user may analyze and re-analyze any process that has been loaded into the system to find process inefficiencies and attempt to find ways to correct or compensate for them. The user can keep analyzing the data using different analytical approaches until a clear interpretation of the data emerges, providing the user a good idea of where problems are occurring.

Each process instance includes a record of its corresponding process definition along with additional data specific to that instance—such as last executed step, and the data came along with the event. The steps of the process instance are executed by the “process engine,” an executable that periodically looks at process instances that require execution.

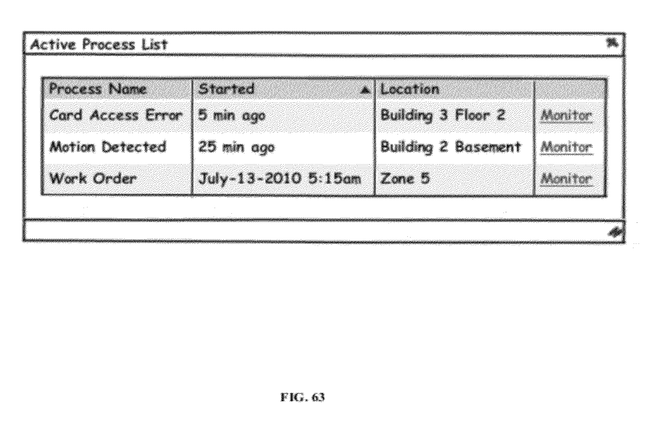

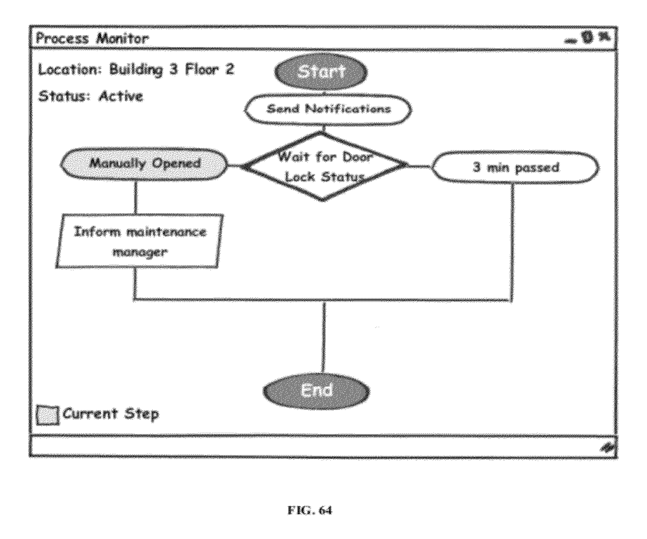

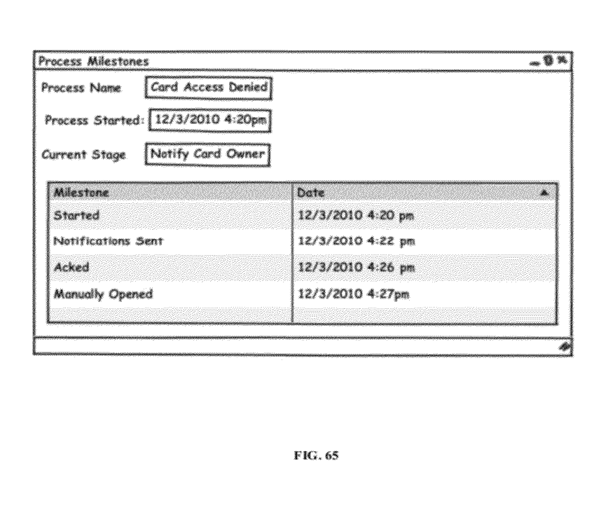

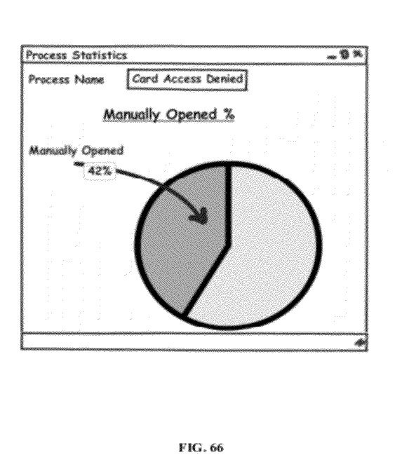

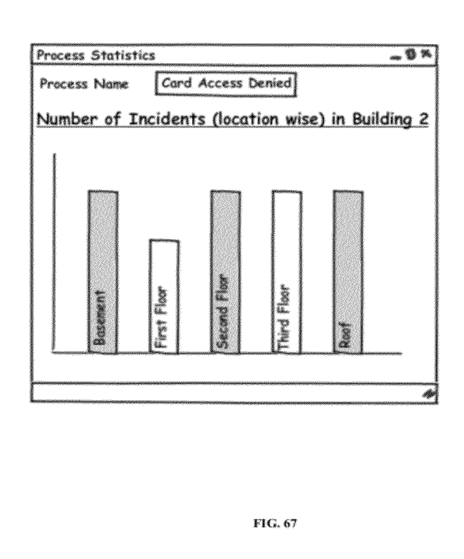

Process instances can be monitored visually with respect to the process definition. FIG. 63 shows an example of a list of active process, and FIG. 64 is a graphic showing the current or last executed step of a selected active process. As shown in FIG. 65, the system can record the details of the process instance (“milestones”) for future analysis. Furthermore, after many process instances have been executed over time, the data from recorded milestones may be presented as “process statistics” for the user's analysis. Examples of such statistical presentations are shown in FIGS. 66 and 67.

In the case where the process to be monitored and/or analyzed is not already represented by a business process template, a business process template may be established as disclosed in U.S. application Ser. No. 12/952,675. The business process template may be a process automation template which initiates and drives a business process upon a particular event or status trigger, or it may be a process monitoring template, which does not automate, initiate or drive any business process or process step but merely monitors existing business processes. Alternatively, the business process template may both automate and monitor a business process.

In the case where process automation is carried out by an independent business system, or where the process is not automated, the present invention may optionally be used solely for process monitoring. According to this embodiment, the meta data layer of the present invention would be configured to gather details relating to the process steps by interfacing with various applications that are used by a user to carry out various steps of the process. Then, a process monitoring template would be defined in the system of the invention, as described in U.S. application Ser. No. 12/952,675, to represent the process to be monitored. This process monitory template would then be annotated with process measurements as described herein in order to monitor and analyze accumulated instances of the process. According to this embodiment then, the present invention does not drive the process, but merely “follows” a process that is driven by another system, or by a human driver, collecting statistics from the systems and applications that are used as the process is carried out. As process instances and related data is accrued, the process may be analyzed as described herein.

1. A computer-implemented method for end user-configurable and end-user editable process automation across a plurality of business (infrastructure) systems and enterprise applications, comprising:
storing on a computer readable medium metadata representations of information from said plurality of business (infrastructure) systems and enterprise applications,
accessing a computer program and selecting from a computer-presented list one or more devices or data from said plurality of business (infrastructure) systems and enterprise applications,
selecting one or more process steps from a computer-presented list of available process steps, wherein at least one of said process steps includes the monitoring, control, or commanding of at least one of said selected devices or data,
using said computer program to assemble selected process steps into a process template and storing said process template on a computer readable medium;
using said process template to automatically drive a business process corresponding to the process steps in the process template based on event or status data represented in said metadata.

2. A computer-implemented method for end user-configurable and end-user editable process monitoring across a plurality of business (infrastructure) systems and enterprise applications, comprising:
storing on a computer readable medium metadata representations of information from said plurality of business (infrastructure) systems and enterprise application
accessing a computer program and selecting from a computer-presented list one or more devices or data from said plurality of business (infrastructure) systems and enterprise applications,
selecting one or more process steps from a computer-presented list of available process steps, wherein said process steps relate to the monitoring of an actual business process,
using said computer program to assemble selected process steps into a process template;
using said computer program to assign one or more process measurements to said process template;
using said process template to automatically monitor an actual business process as the actual business process is carried out;
presenting to a user upon request an analysis of accumulated instances of said actual business process based on said process measurements.

3. A computer-implemented method for end user-configurable and end-user editable process automation across a plurality of business (infrastructure) systems and enterprise applications, comprising:
storing on a computer readable medium metadata representations of information from said plurality of business (infrastructure) systems and enterprise applications,
accessing a computer program and selecting from a computer-presented list one or more devices or data from said plurality of business (infrastructure) systems and enterprise applications,
selecting one or more process steps from a computer-presented list of available process steps, wherein at least one of said process steps includes the monitoring, control, or commanding of at least one of said selected devices or data,
using said computer program to assemble selected process steps into a process template and storing said process template on a computer readable medium;
using said process template to automatically drive a business process corresponding to the process steps in the process template based on event or status data represented in said metadata;
using said process template to automatically monitor said business process as the business process is actually carried out;
presenting to a user upon request an analysis of accumulated instances of said business process based on said process measurements.

4.-7. (canceled)

8. A method according to claim 2, wherein said actual business process is carried out across both enterprise applications and real-time data acquisition systems.

9.-10. (canceled)

11. A method according to claim 2, wherein process measurements are assigned to a process template after a plurality of actual business process instances have occurred.

12.-13. (canceled)

14. A method according to claim 2, wherein said analysis includes the analysis of data collected from two or more versions of said business process.

15.-16. (canceled)

17. A method according to claim 2, wherein said actual business process is executed by an enterprise application or business (infrastructure) system that has been automated by a different system.

18.-19. (canceled)

20. A method according to claim 2, wherein said actual business process is not an automated process.

21.-22. (canceled)

23. A computer-implemented method for allowing a user to configure automated device or application responses in a first building system and at least one enterprise application, comprising providing a process management software module and configuring it to communicate with said first building system and said enterprise application, configuring said process management software module to be accessible over the internet by end users, configuring said process management software module to allow users to configure automated building system and enterprise application response processes using input from said first building system and said enterprise application.

24. A method according to claim 23 wherein said first building system and said enterprise application were not installed together with an integrated control system.

25. A method according to claim 23 wherein said method allows a user to use data from enterprise applications as input for the control of a building system based on business requirements, and to revise the response features of building systems as business requirements change.

26.-27. (canceled)

28. A method according to claim 23, wherein the process management software module can be configured to communicate with additional and replacement building systems and enterprise applications that are added to the building after the process management software module is initially configured, without reconfiguring the entire control system.

29. A method according to claim 23, wherein the process management software module takes the data and control functions from a plurality of building systems and enterprise applications and allows a user to build his or her own intelligent building, and to edit the control processes on their own at any time.

30. A method according to claim 23 wherein the building systems and enterprise applications are selected from the group consisting of HVAC, fire control, access control, video monitoring, public address, exterior lighting and signage, interior public and private space lighting, escalator and elevator systems, telephone systems, room scheduling/reservation systems, resource management systems, data and information technology systems, document management systems, e-mail servers, fax servers, SMS servers, building tenant/visitor database systems, and customer relationship/management systems.

31. A method according to claim 23 wherein the responses of building systems and enterprise applications are process driven and the response process is editable by the user.

32. A method according to claim 31 wherein the user can add or delete steps to the response process using a process design interface.

33. A method according to claim 23 wherein a different process may be configured for every device in a building system.

34. A method according to claim 23 wherein a first user may configure a first building system to respond in a first user's tenant space to a first event according to a first process and a second user may configure said first building system to respond in a second user's tenant space to said first event according to a second process.

35. A method according to claim 23 wherein the process management software module receives input from both value-oriented systems and transaction-oriented systems.

36. A method according to claim 23 wherein an end user may configure and customize building system response systems using input from both value-oriented and transaction-oriented systems.

37. A method according to claim 23 wherein the process management software module receives input from both building systems and enterprise applications.

38. A method according to claim 23 wherein the process management software module issues commands to building systems and enterprise applications.
